(19) United States
(12) Patent Application Publication
(10) Pub. No.: US 2014/0244563 A1
(43) Pub. Date: Aug. 28, 2014

(54) OPERATION INFORMATION PREDICTION COMPUTER, OPERATION INFORMATION PREDICTION METHOD AND PROGRAM

(71) Applicant: Yusuke Atomori, Tokyo (JP)

(72) Inventor: Yusuke Atomori, Tokyo (JP)

(73) Assignee: Hitachi, Ltd.

(21) Appl. No.: 14/352,457

(22) PCT Filed: Nov. 10, 2011
(86) PCT No.: PCT/JP2011/075980

§ 371 Date: Apr. 17, 2014

(51) Int. Cl. G06N 5/02

(52) U.S. Cl. CPC G06N 5/02
USPC 706/46

(57) ABSTRACT

An operation information prediction computer collects operation information from the at least one apparatus, and predicts future operation information on the at least one apparatus based on the collected operation information. The operation information prediction computer collects, from the at least one apparatus, state information including the operation information and configuration information on the at least one apparatus when the operation information is collected. The operation information prediction computer stores the operation information and the configuration information the storage area. The operation information prediction computer calculates a correlation value for associating past operation information stored in the storage area with current configuration information. The operation information prediction computer calculates a future operation prediction value based on the past operation information and the calculated correlation value.

### BACKGROUND OF THE INVENTION

This invention relates to a computer for collecting operation information on an apparatus, and more particularly, to an operation information prediction computer for predicting future operation information based on collected operation information.

In recent years, practical uses of the cloud service and the virtualization service are gaining attention in order to reduce a cost for building, maintaining, and operating an IT system, and to flexibly extend resources. Resulting from this trend, in operation and management of data centers serving as a basis of the cloud service and the virtualization service, a failure symptom detection technology of detecting a silent failure in advance, and addressing the silent failure is also gaining attention. The silent failure refers to a failure which cannot be detected by an autonomous diagnosis function provided in advance on a computer system.

Conventionally, regarding the failure symptom detection technology, an apparatus for collecting operation information on an IT system, accumulating the collected operation information, calculating a baseline based on the past operation information, and detecting a symptom of a failure based on the baseline is known (for example, refer to Japanese Patent Application Laid-open No. 2004-164637).

The apparatus disclosed in Japanese Patent Application Laid-open No. 2004-164637 collects performance data on the IT system at a predetermined interval for a certain period, and acquires weighted average of the collected performance data, thereby generating the baseline. Then, this apparatus calculates a predicted upper/lower limit range (thresholds) of next performance data by means of a statistical analysis model while using a tendency, a period, a sensitivity, and the like as parameters. It should be noted that if the current performance data exceeds the threshold, the apparatus reports the event, thereby detecting a symptom of a failure.

### SUMMARY OF THE INVENTION

As systems such as the cloud service and the virtualization service develop, frequency of a change in configuration information on resources and the like (such as assignment rate of a CPU and an assignment rate of a memory) can increase in the IT system depending on a load state in an IT system.

FIG. 23 is an explanatory diagram illustrating a relationship between the configuration information on a related-art IT system and a response performance (operation information) of the IT system. In this diagram, the configuration information on the IT system includes a CPU assignment rate and a database (DB) cache. The CPU assignment rate represents a ratio in percentage of the CPU assigned to a virtual computer generated by the IT system, and the DB cache represents a capacity in megabytes of a DB cache assigned to the IT system.

As illustrated in this diagram, if the configuration information on the resource and the like of the IT system changes, the response performance of the IT system changes. The configuration information on the IT system is changed four times, and is represented as respective states (a) to (e) of the configuration information.

In the state (a), the CPU assignment rate is 20% and the DB cache is 1 MB. Then, the CPU assignment rate and the DB cache are changed from the state (a) to the state (b). In the state (b), the CPU assignment rate is 30% and the DB cache is 1.5 MB.

Then, the CPU assignment rate is changed from the state (b) to the state (c). In the state (c), the CPU assignment rate is 45% and the DB cache is 1.5 MB, which is the same as that in the state (b).

Then, the DB cache is changed from the state (c) to the state (d). In the state (d), the CPU assignment rate is 45%, which is the same as that in the state (c), and the DB cache is 2 MB.

Then, the CPU assignment rate is changed from the state (d) to the state (e). In the state (e), the CPU assignment rate is 35%, and the DB cache is 2 MB, which is the same as that in the state (d).

The response performance when the configuration information is in the state (a) is illustrated in 3-a in FIG. 23. The response performance when the configuration information is in the state (b) is illustrated in 3-b and 2-b in FIG. 23. The response performance when the configuration information is in the state (c) is illustrated in 2-c and 1-c in FIG. 23. The response performance when the configuration information is in the state (d) is illustrated in 1-d in FIG. 23. The response performance when the configuration information is in the state (e) is illustrated in 1-e in FIG. 23.

As illustrated in the response performances 3-a to 1-e, the response performance changes depending on the configuration information.

FIG. 24 is an explanatory diagram illustrating related-art calculation processing for baseline. The baseline is a predicted value of the future response performance. The related-art calculation processing of the baseline is processing of calculating an average of the response performances at the same time on different days, and setting the calculated average as the baseline.

FIG. 25 is an explanatory diagram illustrating a related-art relationship between the baseline and the current response performance. In FIG. 25, a baseline upper limit is calculated by adding a predetermined value to the baseline calculated based on the response performances for configuration information different from the current configuration information as described in FIG. 24, and a baseline lower limit is calculated by subtracting the predetermined value from the baseline. Then, if the current response performance is not in a range between the baseline upper limit and the baseline lower limit, a symptom of an abnormality in the IT system is detected. However, in the related art, the baseline is calculated based on the response performance for the configuration information different from the current configuration information. Therefore, as illustrated in FIG. 25, the current response performance is not in the range between the baseline upper limit and the baseline lower limit, and a baseline desired by the administrator cannot be calculated.

Therefore, there is such a problem in that a symptom of an abnormality of the IT system cannot be detected immediately after the configuration information is changed, and unless the configuration information after the change is accumulated for a period ranging from at least one hour to one day, the baseline corresponding to the configuration information after the change cannot be calculated.

In view of the above, this invention has an object to provide a computer which can predict future operation information immediately after the configuration information is changed.

A description is now given of a representative example of this invention herein disclosed. An operation information prediction computer for collecting operation information on at least one apparatus from the at least one apparatus and predicting future operation information on the at least one apparatus based on the collected operation information, the operation information prediction computer comprising: a storage area; a state information collection part for collecting, from the at least one apparatus, state information including the operation information and configuration information on the at least one apparatus when the operation information is collected; a state information storage part for storing the operation information and the configuration information collected by the state information collection part in the storage area; a correlation value calculation part for calculating a correlation value for associating past operation information stored in the storage area by the state information storage part with current configuration information; and an operation prediction value calculation part for calculating a future operation prediction value based on the past operation information and the correlation value calculated by the correlation value calculation part.

According to one embodiment of the present invention, it is possible to provide computer which can predict future operation information immediately after the configuration information is changed.

### BRIEF DESCRIPTION OF THE DRAWINGS

FIG. 1 is an explanatory diagram illustrating an overview of a baseline calculation method according to an embodiment of this invention.

FIG. 2A is an explanatory diagram showing an overview of correlation value calculation processing for a CPU assignment rate according to the embodiment of this invention.

FIG. 2B is an explanatory diagram showing an overview of the correlation value calculation processing for a DB cache according to the embodiment of this invention.

FIG. 3 is an explanatory diagram illustrating an overview of correction processing for a baseline according to the embodiment of this invention.

FIG. 4 is an explanatory diagram showing an overview of correlation value change processing according to the embodiment of this invention.

FIG. 5 is a system configuration diagram of a failure symptom detection system according to the embodiment of this invention.

FIG. 6 is a functional block diagram of the failure symptom detection system according to the embodiment of this invention.

FIG. 7 is a flowchart illustrating overall processing by the failure symptom detection system according to the embodiment of this invention.

FIG. 8 is an explanatory diagram illustrating configuration information collected from an IT system according to the embodiment of this invention.

FIGS. 9A and 9B are explanatory diagrams illustrating observation subject information collection processing according to the embodiment of this invention until a stream data processing part stores state values of the IT system collected by a state management part in a state value storage DB.

FIG. 10 is a flowchart illustrating observation subject information collection processing according to the embodiment of this invention.

FIG. 11 is an explanatory diagram illustrating baseline generation processing according to this invention up to generation of the baseline.

FIG. 12 is an explanatory diagram illustrating the correlation function calculation processing according to the embodiment of this invention.

FIG. 13 is a flowchart illustrating the baseline generation processing of reflecting correlation values according to the embodiment of this invention in a preliminary baseline.

FIG. 14 is a flowchart illustrating the baseline generation processing of reflecting the correlation values according to the embodiment of this invention in the state values.

FIG. 15 is an explanatory diagram showing processing of detecting an abnormality in a baseline after correction by a relative comparison part according to the embodiment of this invention.

FIG. 16 is an explanatory diagram illustrating processing of changing a correlation function by the relative comparison part according to the embodiment of this invention.

FIG. 17 is a flowchart illustrating relative comparison processing by the relative comparison part according to the embodiment of this invention.

FIG. 18 is an explanatory diagram showing abnormality detection processing according to the embodiment of this invention.

FIG. 19 is a flowchart illustrating the abnormality detection processing when thresholds are calculated by statistical-amount-using threshold calculation processing according to the embodiment of this invention.

FIG. 20 is a flowchart illustrating the abnormality detection processing when the thresholds are calculated by certain-value-using threshold calculation processing according to the embodiment of this invention.

FIG. 21 is an explanatory diagram illustrating an abnormality detection screen according to the embodiment of this invention.

FIG. 22 is a flowchart illustrating notification processing according to the embodiment of this invention.

FIG. 23 is an explanatory diagram illustrating a relationship between the configuration information on a related-art IT system and a response performance of the IT system.

FIG. 24 is an explanatory diagram illustrating related-art calculation processing for baseline.

FIG. 25 is an explanatory diagram illustrating a related-art relationship between the baseline and the current response performance.

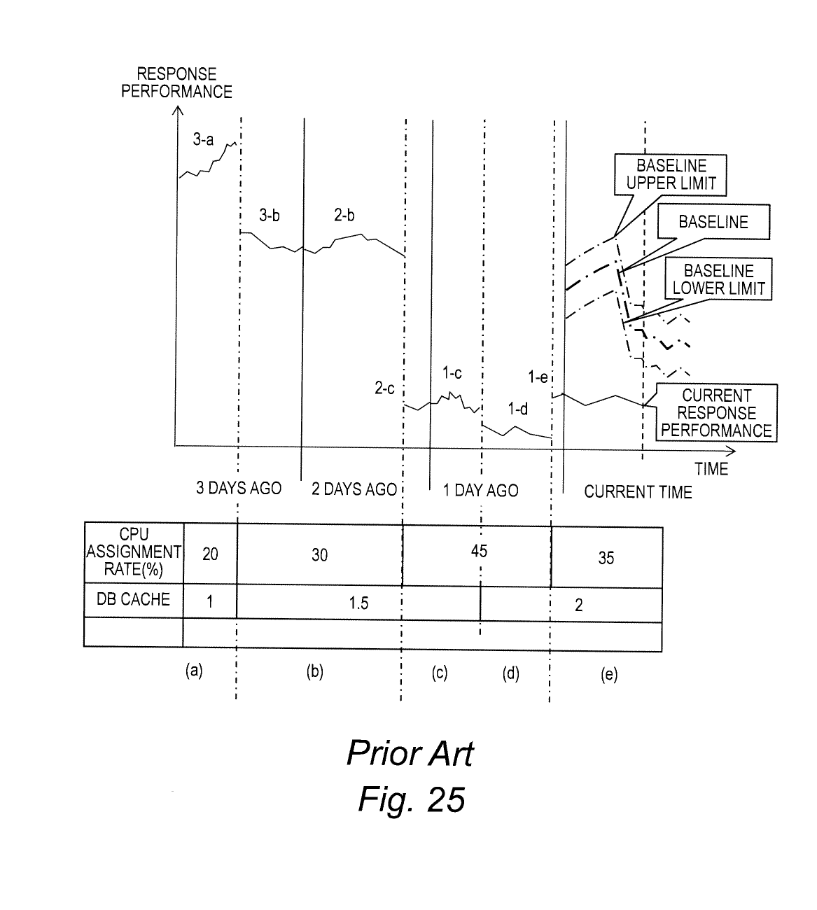

### DETAILED DESCRIPTION OF THE PREFERRED EMBODIMENT

An embodiment of this invention is described below referring to the accompanying drawings. In order to clarify the description, in the following description and the drawings, some omissions and simplification are made as needed. Further, the same reference numerals are given to the same elements throughout the drawings to avoid redundant descriptions as needed for clarification of the description.

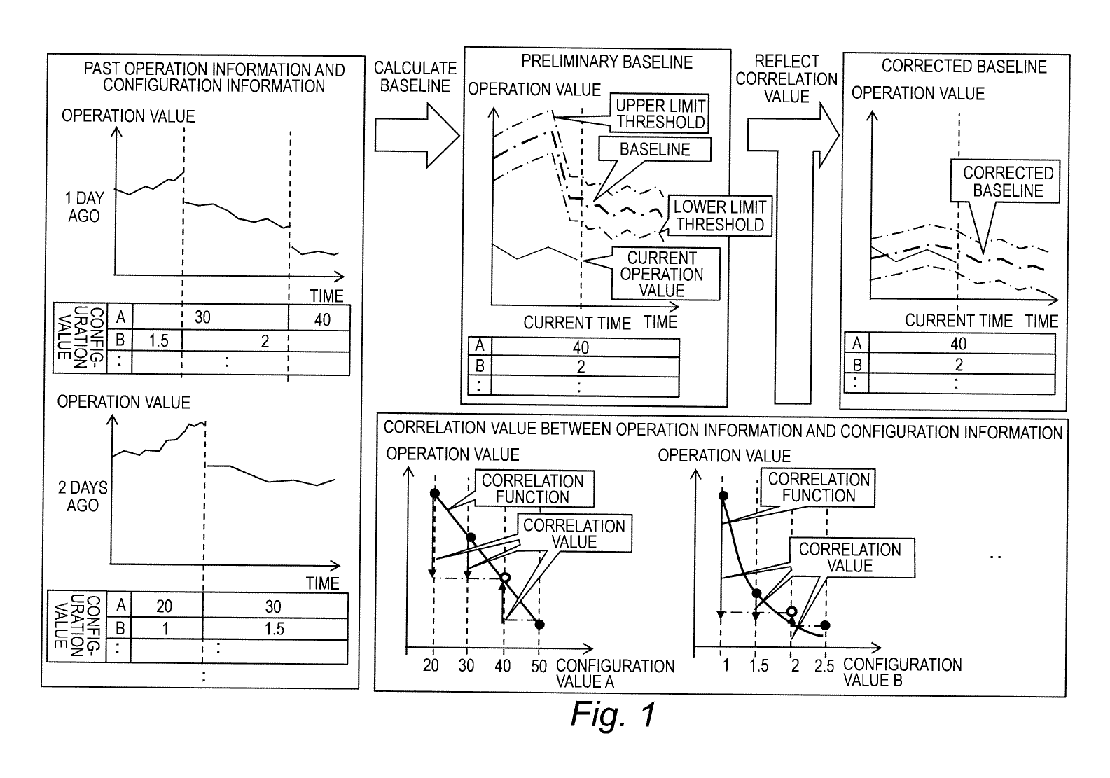

A description is now given of the embodiment of this invention referring to FIGS. 1 to 22.

FIG. 1 is an explanatory diagram illustrating an overview of a baseline calculation method according to the embodiment of this invention.

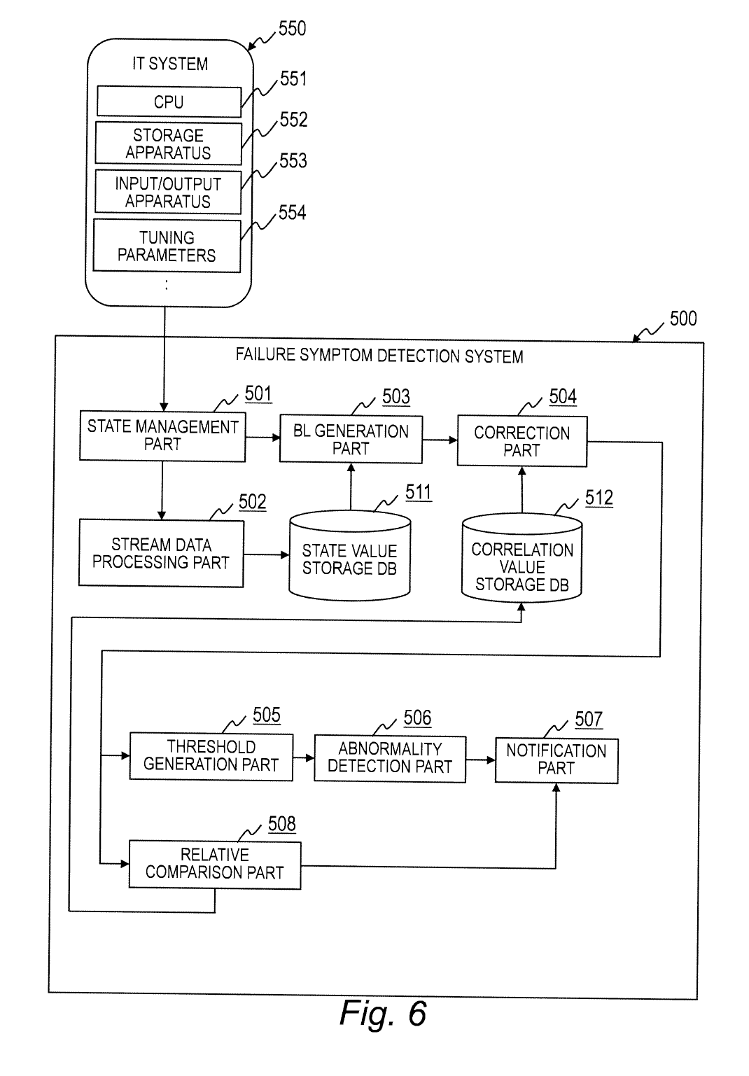

A failure symptom detection system 500 (refer to FIG. 5) according to this embodiment collects configuration information as well as operation information from an apparatus (IT system 500 (refer to FIG. 5)) subject to observation, and stores the collected operation information and configuration information as time series in a storage area.

Then, the failure symptom detection system 500 calculates a correlation function based on the operation information and the configuration information stored in the storage area. Then, the failure symptom detection system 500 calculates a correlation value for associating the past operation information stored in the storage area based on the correlation function to the current configuration information.

Moreover, the failure symptom detection system 500 calculates a preliminary baseline based on the operation information stored in the storage area.

Then, the failure symptom detection system 500 reflects the correlation value in the preliminary baseline, thereby correcting the preliminary baseline to generate a baseline.

As a result, if the configuration information is changed, the failure symptom detection system 500 can detect a symptom of a failure of the IT system 550 immediately after the configuration information is changed without collecting the configuration information after the change for a predetermined period.

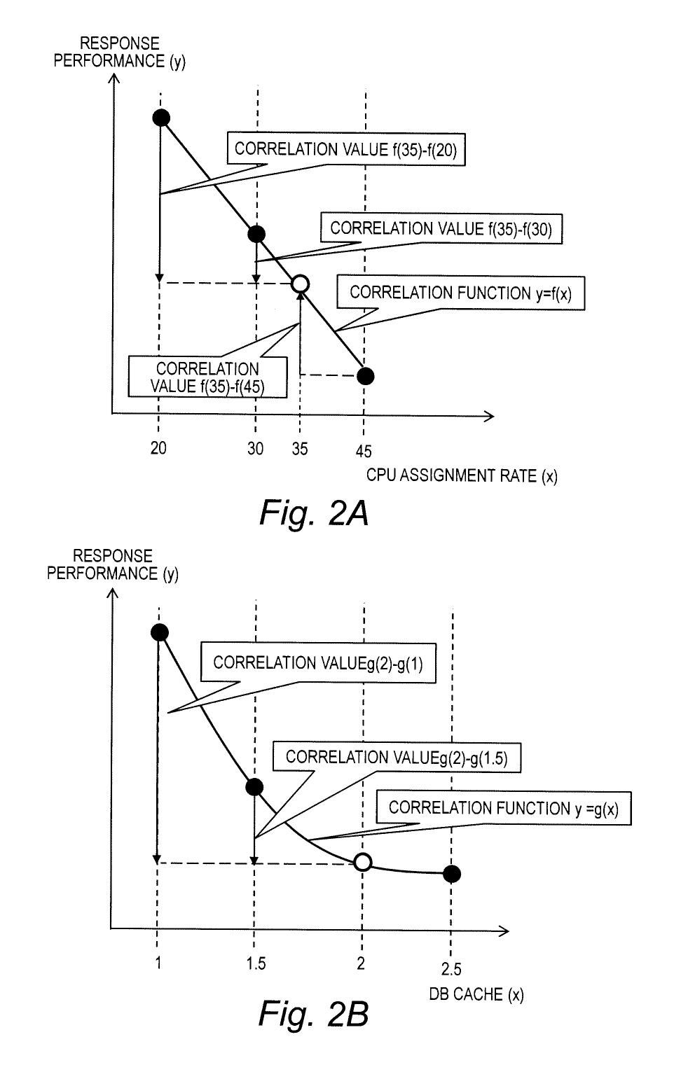

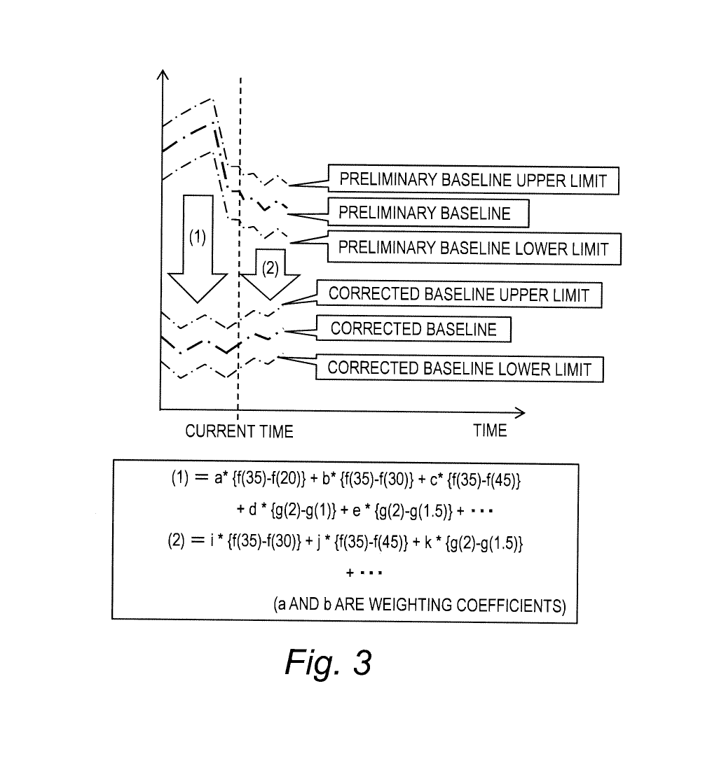

Referring to FIGS. 2A and 2B, a description is now given of an overview of correlation value calculation processing for each piece of the configuration information according to this embodiment. It should be noted that, referring to FIGS. 2A and 2B, a description is given of the CPU assignment rate and the DB cache as examples of the configuration information, and of the response performance as an example of the operation information.

FIG. 2A is an explanatory diagram showing an overview of the correlation value calculation processing for the CPU assignment rate according to the embodiment of this invention.

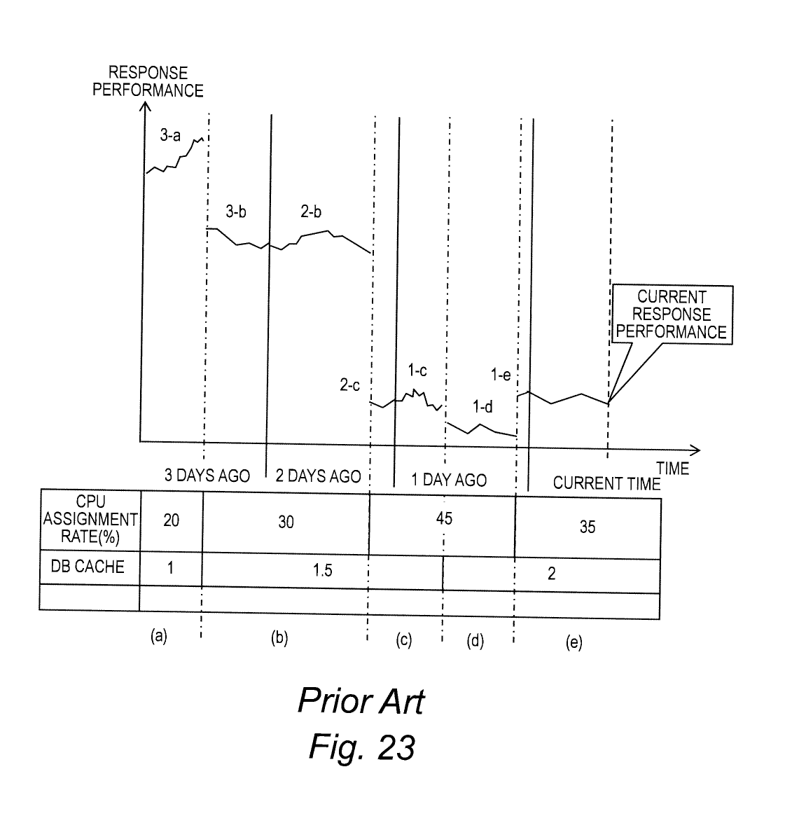

First, the failure symptom detection system 500 plots the CPU assignment rate and the response performance stored in the storage area while the CPU assignment rate is assigned to the x axis and the response performance is assigned to the y axis. It should be noted that the CPU assignment rate, the DB cache, and the response performance stored in the storage area are the same as those illustrated in FIG. 23.

Then, the failure symptom detection system 500 calculates a function (correlation function) (y=f(x)) passing through the plotted CPU assignment rate and response performance.

Then, the failure symptom detection system 500 calculates a correlation value for associating the response performance of each CPU assignment rate stored in the storage area to a current CPU assignment rate based on the correlation function.

Specifically, the failure symptom detection system 500 subtracts a value acquired by assigning the current CPU assignment rate to the correlation function from a value acquired by assigning the each CPU assignment rate stored in the storage area to the correlation function, thereby calculating the correlation value for the each CPU assignment rate stored in the storage area.

FIG. 2A shows the correlation values for CPU assignment rates of 20%, 30%, and 45% when the current CPU assignment rate is 35%. The correlation value when the CPU assignment rate is 20% is represented as f(35)−f(20). The correlation value when the CPU assignment rate is 30% is represented as f(35)−f(30). The correlation value when the CPU assignment rate is 45% is represented as f(35)−f(45).

FIG. 2B is an explanatory diagram showing an overview of the correlation value calculation processing for the DB cache according to the embodiment of this invention.

The correlation value of the DB cache is calculated by the same processing as that for the correlation value of the CPU assignment rate described while referring to FIG. 2A.

When the current DB cache is 2 MB and the correlation function of the DB cache is represented as y=g(x), a correlation value when the DB cache is 1 MB is represented as g(2)−g(1). The correlation value when the DB cache is 1.5 MB is represented as g(2)−g(1.5).

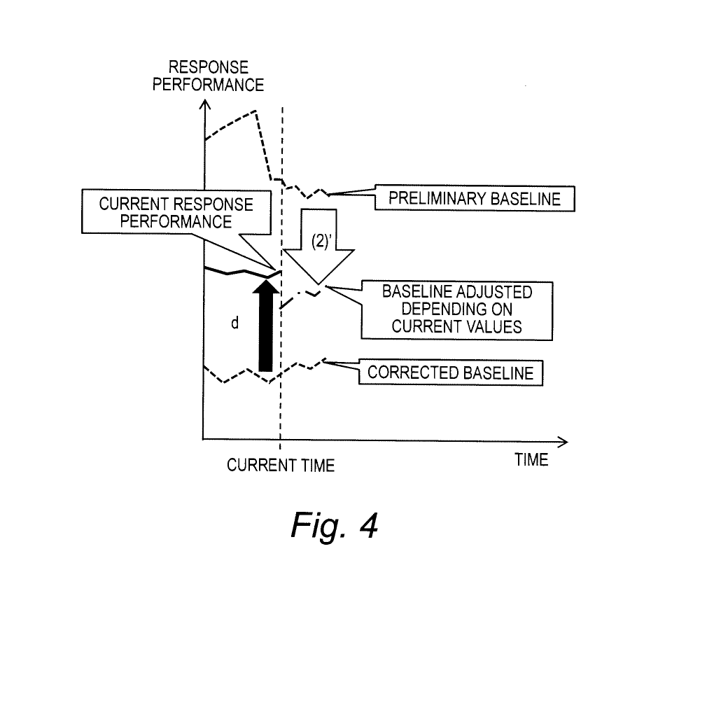

FIG. 3 is an explanatory diagram illustrating an overview of correction processing for the baseline according to the embodiment of this invention.

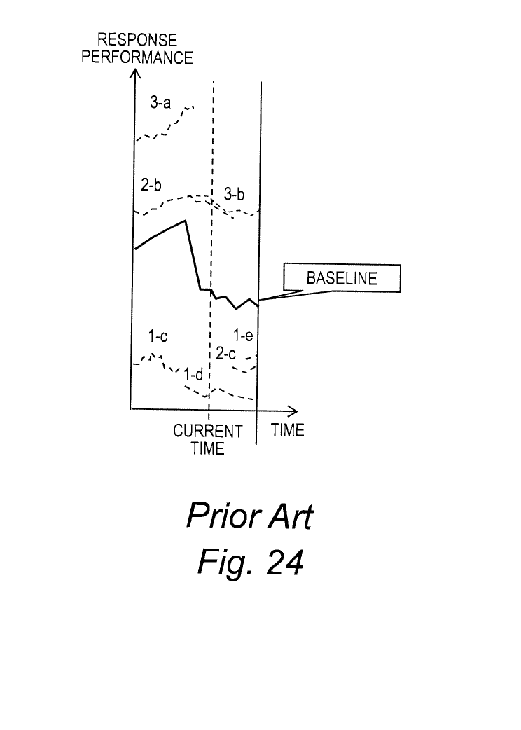

FIG. 3 illustrates a preliminary baseline calculated by the same processing as that in FIG. 24. The configuration information for the response performance is divided into regions (1) and (2) illustrated in FIG. 3 so as to calculate the preliminary baseline.

Specifically, the preliminary baseline in the region (1) illustrated in FIG. 3 is calculated by using the response performances 3-a, 2-b, 1-c, and 1-d as illustrated in FIG. 23. Referring to FIG. 23, these pieces of configuration information (CPU assignment rate, DB cache) for the response performances are 3-a(20,1), 2-b(30,1.5), 1-c(45,1.5), and 1-d(45,2) in sequence.

On the other hand, the preliminary baseline in the region (2) illustrated in FIG. 3 is calculated by using the response performances 3-b, 2-b, 1-e, 2-c, and 1-d as illustrated in FIG. 23. Referring to FIG. 23, these pieces of configuration information (CPU assignment rate, DB cache) for the response performances are 3-b(30,1.5), 2-b(30,1.5), 1-e(35,2), 2-c(45,1.5), and 1-d(45,2) in sequence.

Therefore, a value used to correct the preliminary baseline in the region (1) is calculated based on the respective correlation values for the CPU assignment rates of 20%, 30%, and 45%, and the respective correlation values for the DB caches of 1 MB and 1.5 MB.

A value used to correct the preliminary baseline in the region (2) is calculated based not on the correlation value for the CPU assignment rate of 20% and the correlation value for the DB cache of 1 MB, but on the respective correlation values for the CPU assignment rates of 30% and 45%, and the correlation value for the DB cache of 1.5 MB.

As illustrated in FIG. 3, the values for correcting the preliminary baseline are values each obtained by summing products of each correlation value and a weighting coefficient set for each of the pieces of configuration information.

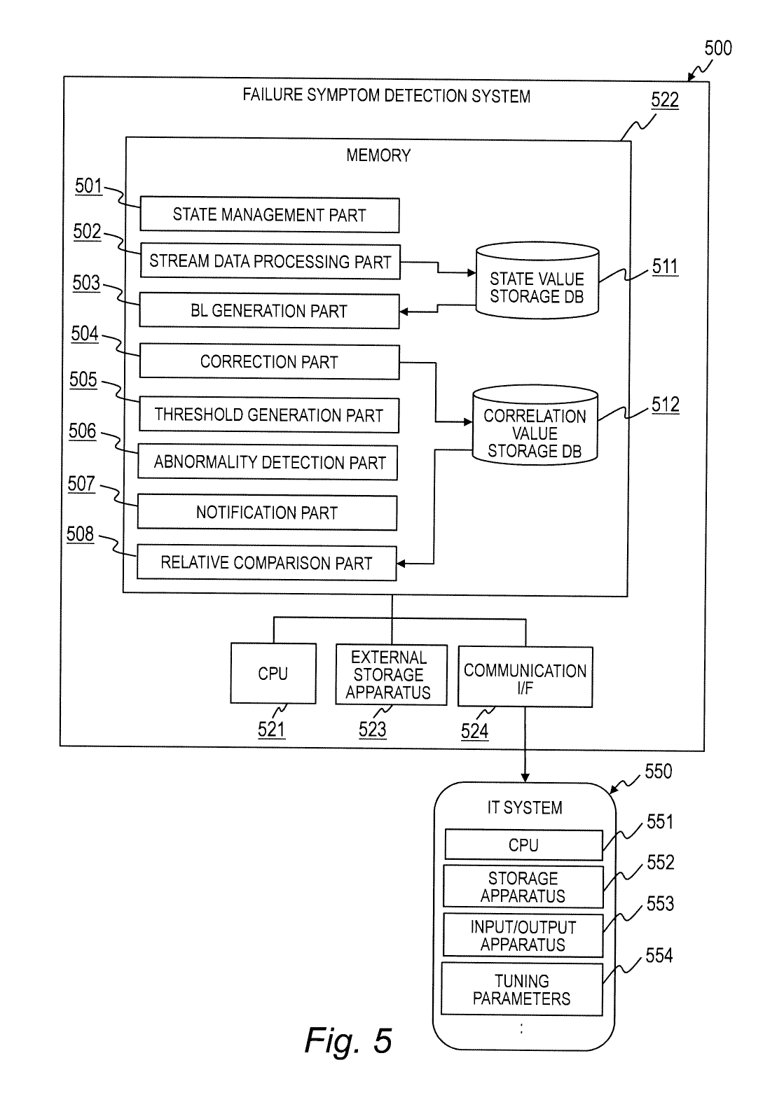

FIG. 4 is an explanatory diagram showing an overview of correlation value change processing according to the embodiment of this invention.

As shown in FIG. 4, if the current response performance is in a range between the preliminary baseline and the corrected baseline, at least one of the correlation function and the weighting coefficients is changed so as to decrease a difference (d) between the current response performance and the corrected baseline, thereby changing the correlation values of the respective pieces of configuration information.

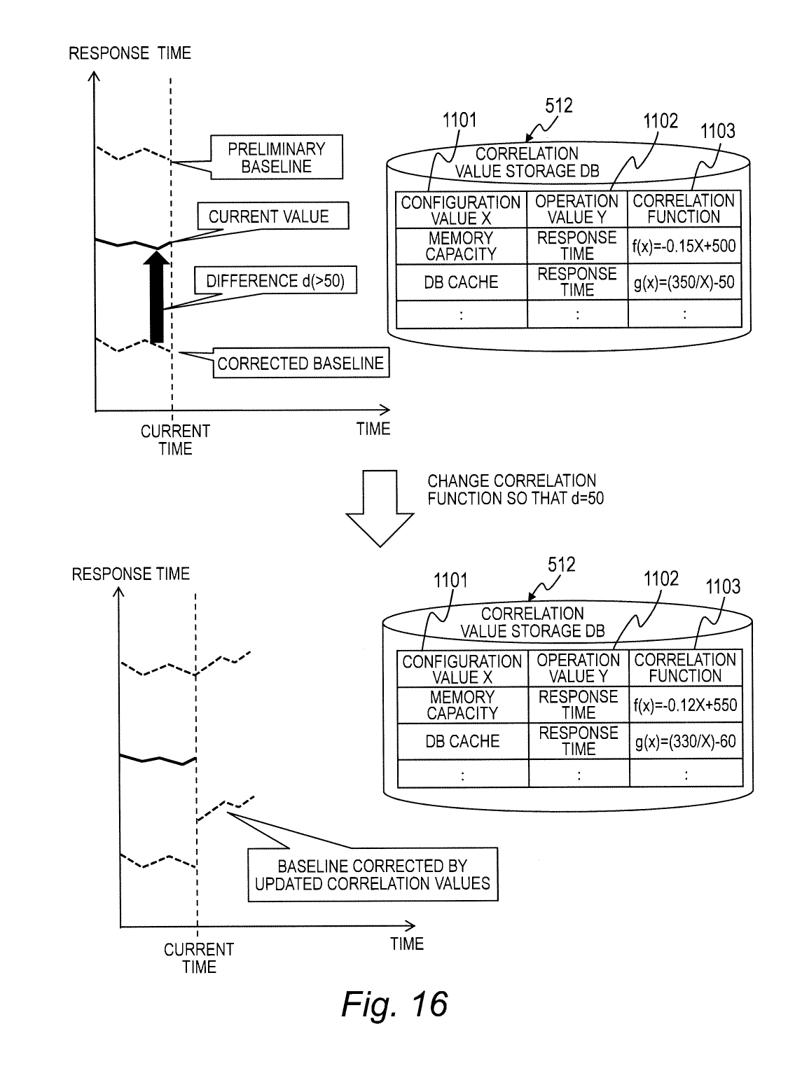

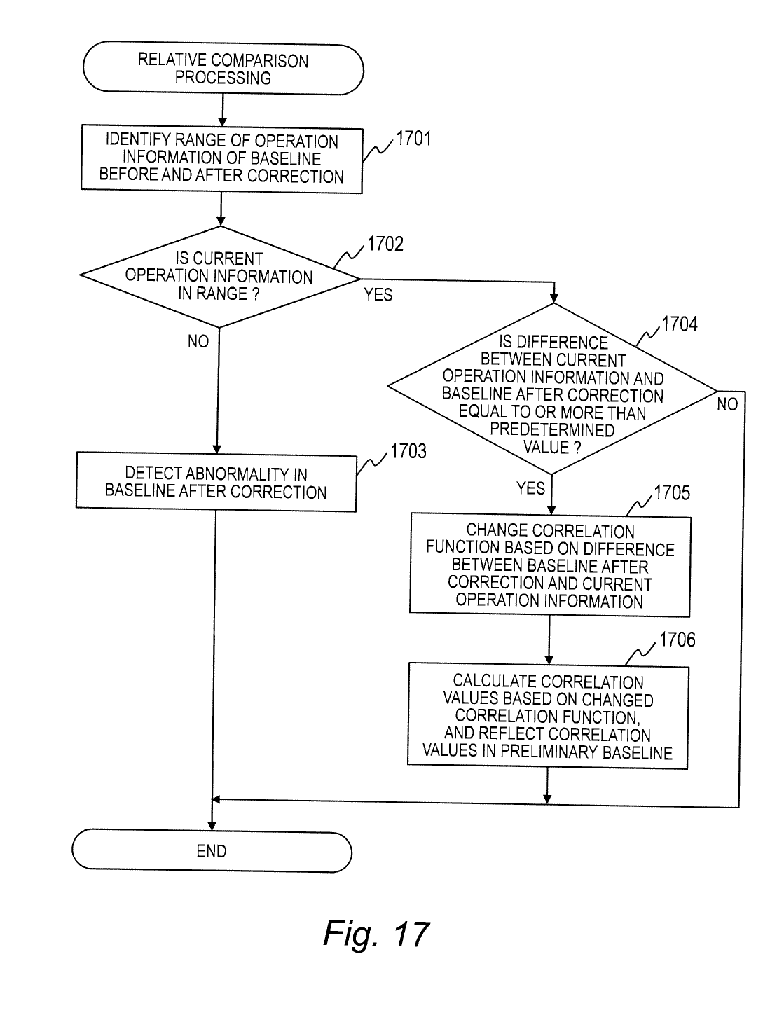

The correlation value change processing is detailed referring to FIGS. 16 and 17.

FIG. 5 is a system configuration diagram of the failure symptom detection system 500 according to the embodiment of this invention. The failure symptom detection system 500 is connected to the IT system 550 subject to monitoring.

The failure symptom detection system 500 includes a CPU 521, a memory (storage area) 522, an external storage apparatus 523, and a communication interface (I/F) 524.

The CPU 521 executes various programs stored in the memory 522.

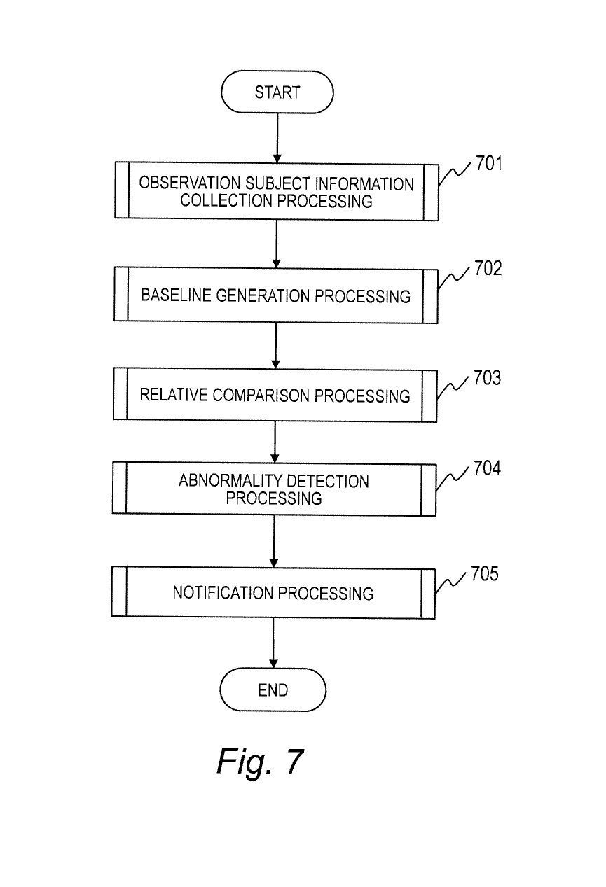

The memory 522 stores a state management part 501, a stream data processing part 502, a baseline (BL) generation part 503, a correction part 504, a threshold generation part 505, an abnormality detection part 506, a notification part 507, and a relative comparison part 508 as programs. Moreover, the memory 522 stores a state value storage database (DB) 511 and a correlation value storage database (DB) 512 as databases. Referring to FIG. 6, a detailed description is given of the various programs and the various databases stored in the memory 522.

It should be noted that the various programs and various databases stored in the memory 522 may be stored in the external storage apparatus 523, and the CPU 521 may load them from the external storage apparatus 523 on the memory 522 depending on necessity, and may execute or refer to them.

The communication I/F 524 is connected to an apparatus communicating with the failure symptom detection system 500. Specifically, the communication I/F 524 is connected to the IT system 550 subject to observation and a client PC, which is not shown, operated by the administrator.

It should be noted that the programs for realizing functions of the respective parts do not need to be stored in one memory. The programs may be distributed to and stored in memories of a plurality of computers, and the plurality of computers may realize the failure symptom detection system 500.

In addition, information on programs, tables, files, and the like for realizing the respective functions may be stored in a storage device, such as a nonvolatile semiconductor memory, a hard disk drive, and a solid state drive (SSD), or a non-transitory computer readable data storage medium, such as an IC card, an SD card, and a DVD.

The IT system 550 includes a CPU 551, a storage apparatus 552, an input/output apparatus 553, and tuning parameters 554.

The CPU 551 executes the various programs stored in the storage apparatus 552. The storage apparatus 552 stores the various programs and the like. The input/output apparatus 553 includes an apparatus (such as a mouse and a keyboard) for inputting various types of data into the IT system 550, and an apparatus (such as a display and a printer) for outputting various types of data. The tuning parameters 554 are values of various parameters for various types of software, and usually stored in the storage apparatus 552.

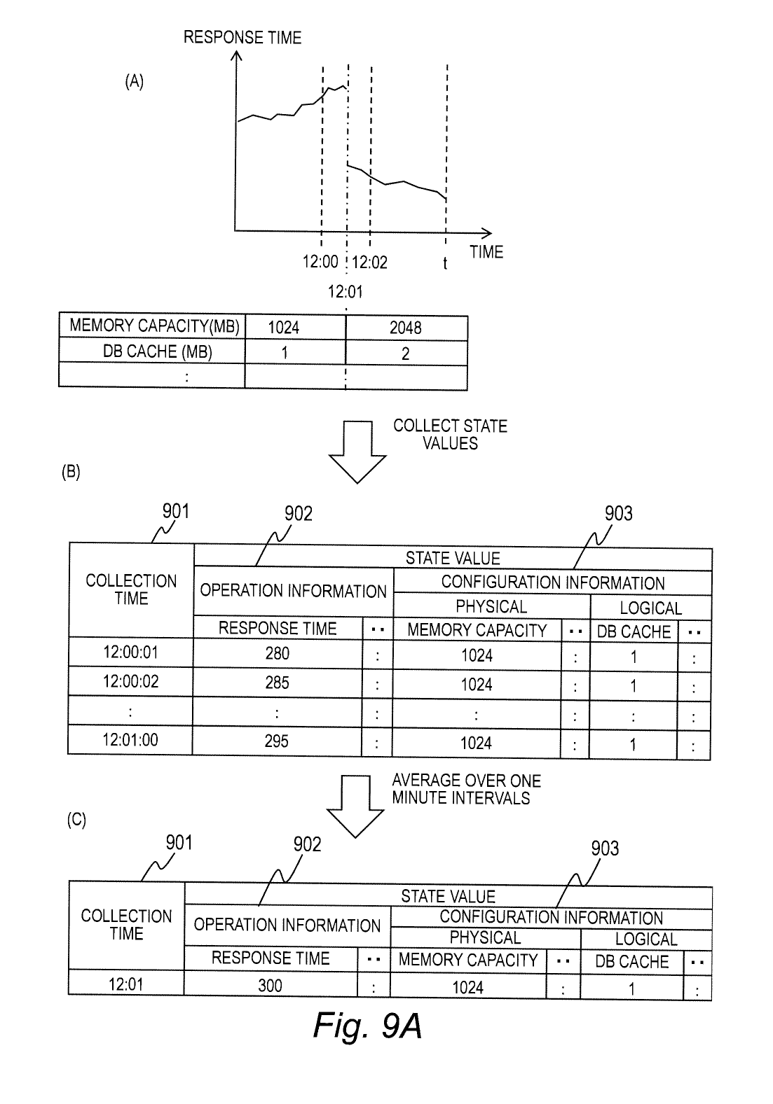

FIG. 6 is a functional block diagram of the failure symptom detection system 500 according to the embodiment of this invention. The state management part 501 collects the operation information and the configuration information from the IT system 550, and inputs state information (state values) acquired by adding the collected configuration information to the collected operation information into the stream data processing part 502. Referring to FIG. 8, a detailed description is given of the configuration information collected by the state management part 501.

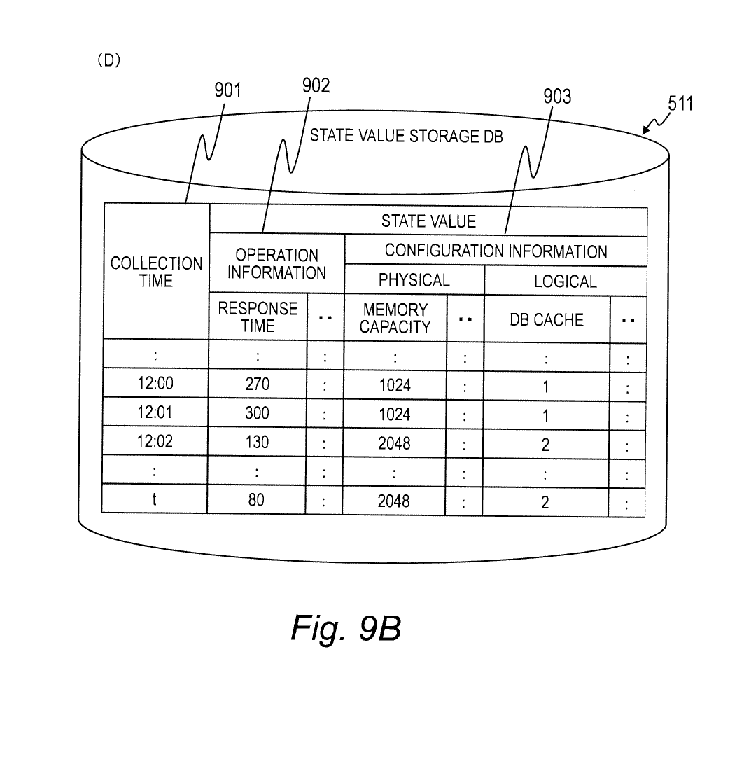

The stream data processing part 502 temporarily holds the state values input from the state management part 501, averages the operation information and the configuration information included in the state values at a predetermined period (such as one minute), and stores the averaged operation information and configuration information in the state value storage DB 511. Referring to FIGS. 9A and 9B, a detailed description is given of the processing by the stream data processing part 502 to store the operation information and the configuration information in the state value storage DB 511, and of the state value storage DB 511.

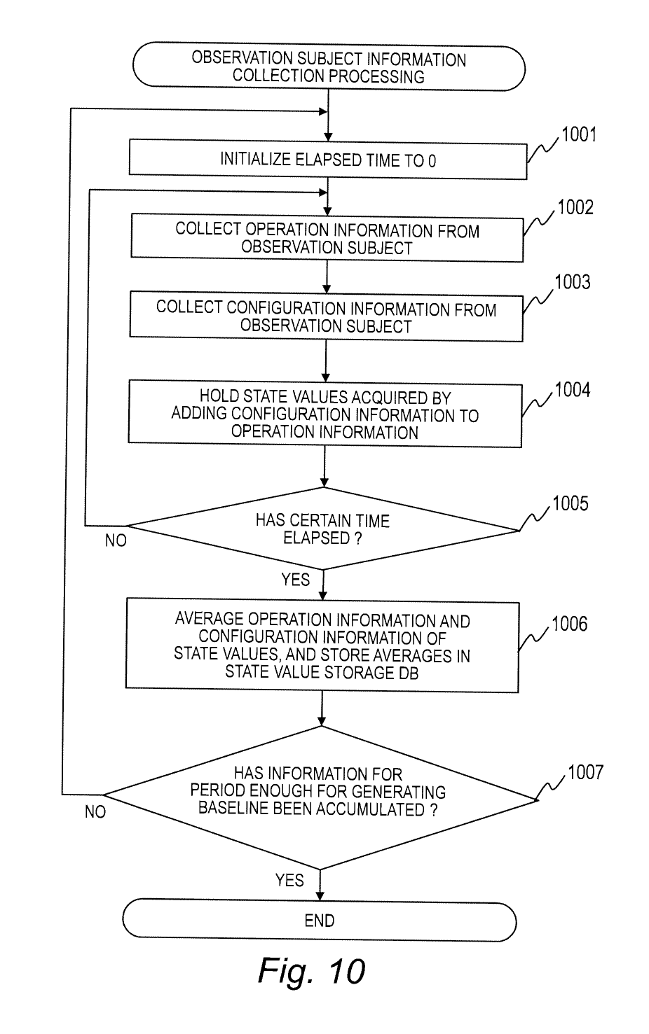

Moreover, a series of pieces of processing in which the state management part 501 collects the operation information and the configuration information, and the stream data processing part 502 stores the operation information and the configuration information in the state value storage DB 511 is referred to as observation subject information collection processing, and, referring to FIG. 10, a detailed description is given of the observation subject information collection processing.

The BL generation part 503 acquires the past state values stored in the state value storage DB 511, calculates, as the preliminary baseline, a statistical amount using the acquired past operation information as a parameter, and inputs the calculated preliminary baseline into the correction part 504. Specifically, as described in FIG. 24, the BL generation part 503 calculates the preliminary baseline by averaging the operation information at the same time point on different days.

If the configuration information used to calculate the preliminary baseline input from the BL generation part 503 and the current configuration information are different from each other, the correction part 504 acquires the correlation function stored in the correlation value storage DB 512, calculates correlation values based on the acquired correlation function, and reflects the calculated correlation values to the preliminary baseline to calculate a baseline, which is the preliminary baseline adapted to the current configuration information.

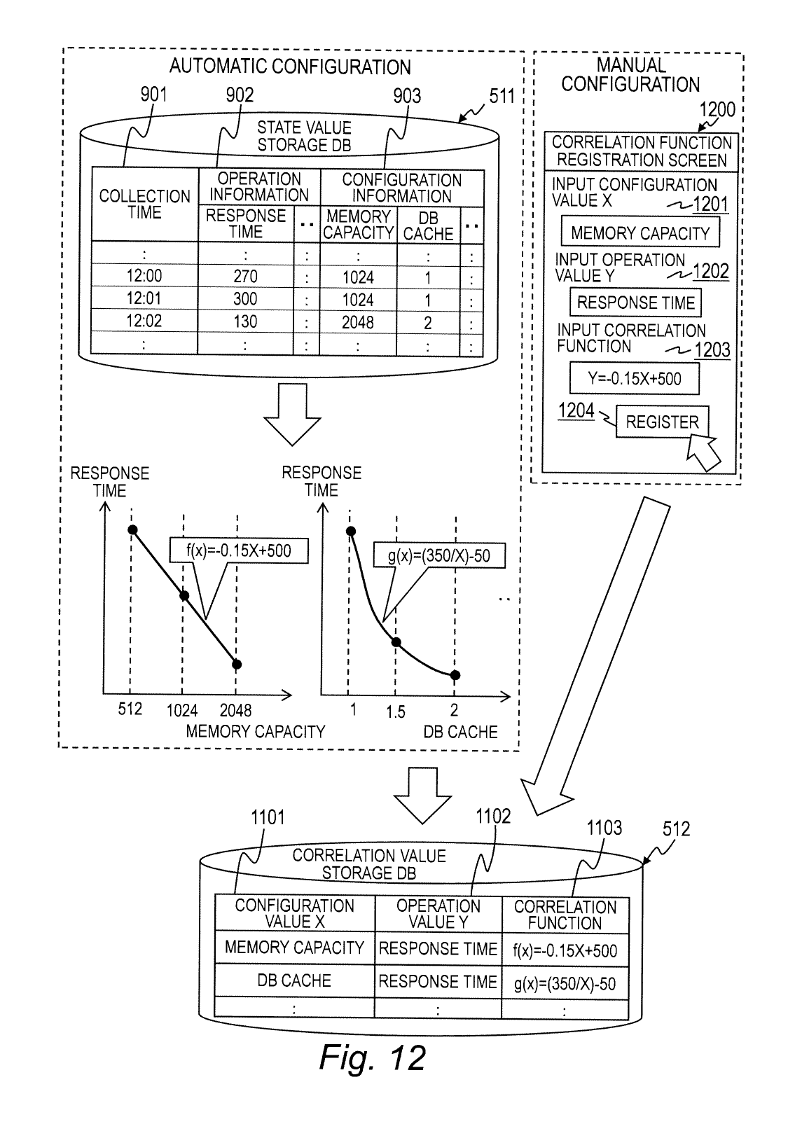

It should be noted that the correlation function is a function representing a correspondence between the operation information and the configuration information stored in the state value storage DB 511. Setting processing for the correlation function includes correlation value automatic setting processing of carrying out, by the failure symptom detection system 500, automatic setting based on the past operation information and configuration information stored in the state value storage DB 511, and correlation value manual setting processing of carrying out manual setting by the administrator. Referring to FIG. 12, a detailed description is given of the correlation value automatic setting processing and the correlation value manual setting processing.

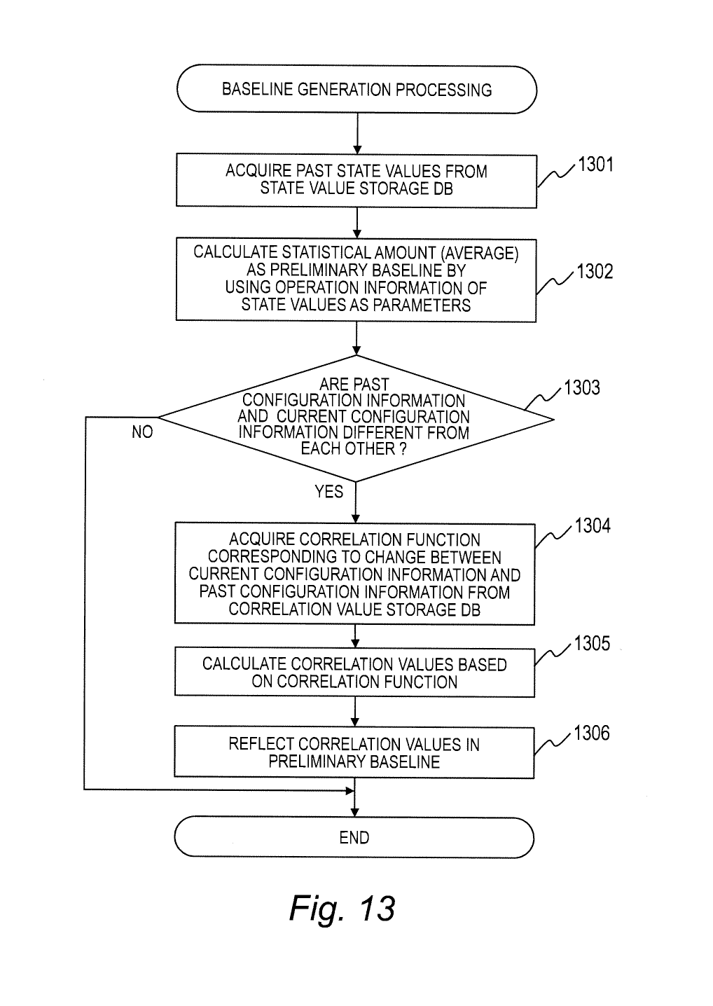

Moreover, referring to FIG. 13, a detailed description is given of the processing of carrying out, by the correction part 504, the correction of the preliminary baseline, thereby calculating the baseline.

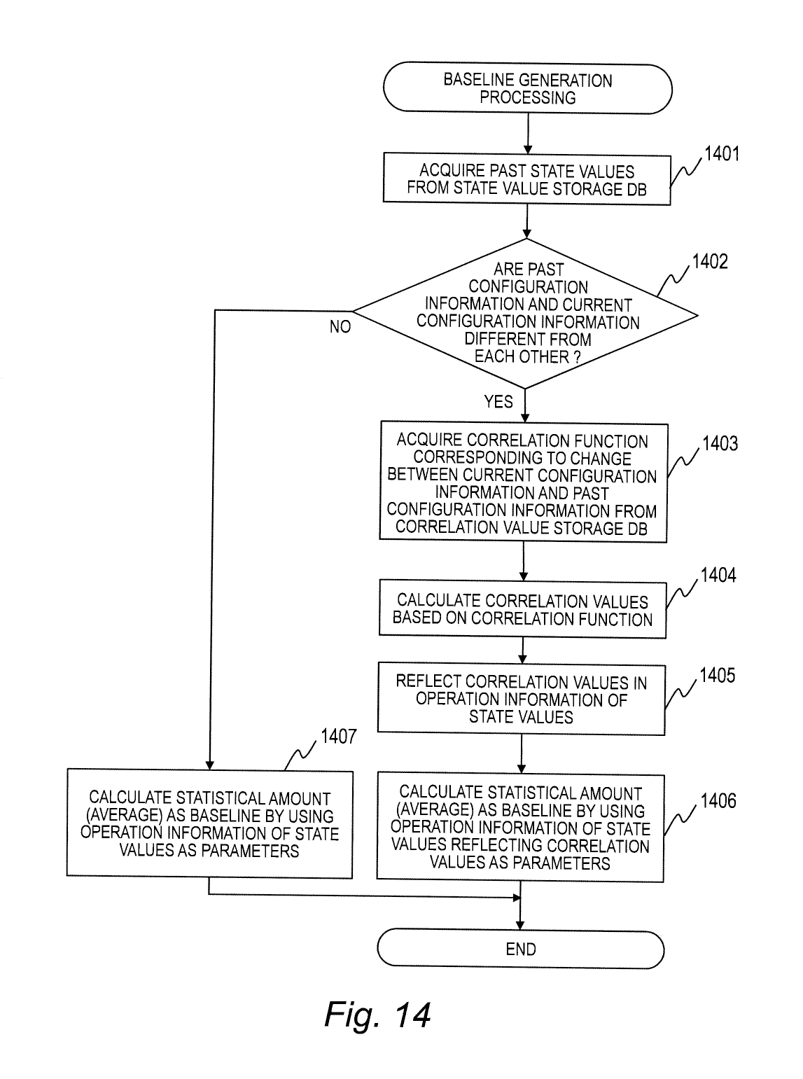

Moreover, the BL generation part 503 may not generate the baseline, and the correction part 504 may reflect the correlation values in the operation information stored in the state value storage DB 511, and may calculate the baseline based on the operation information which reflects the correlation values. Referring to FIG. 14, a detailed description is given of the baseline calculation processing.

The relative comparison part 508 compares the preliminary baseline and the baseline acquired by correcting the preliminary baseline, and the current operation information with each other, thereby verifying a tendency of a change in the operation information caused by the change in the configuration information.

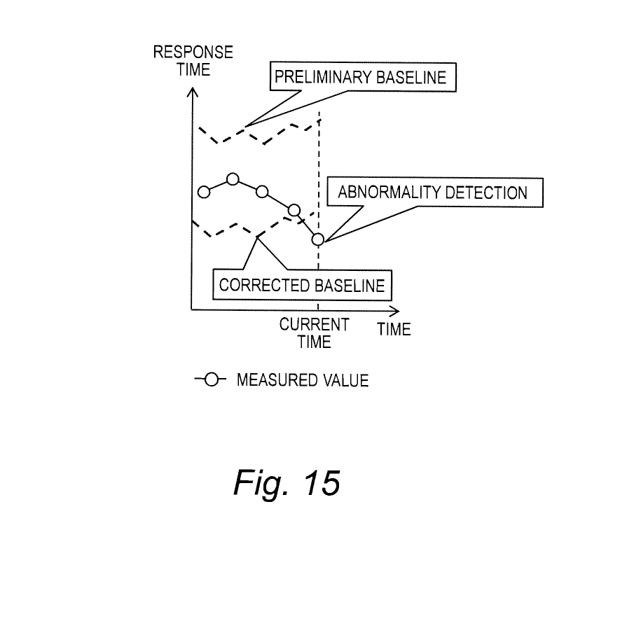

Specifically, the relative comparison part 508 determines whether or not the current operation information is in the range of the difference between the preliminary baseline and the baseline after the correction. If the relative comparison part 508 determines that the current operation information is not in the range of the difference between the preliminary baseline and the baseline after the correction, the relative comparison part 508 detects that the baseline after the correction is abnormal. Referring to FIG. 15, a detailed description is given of the processing of detecting the abnormality of the baseline after the correction by the relative comparison part 508.

On the other hand, if the relative comparison part 508 determines that the current operation information is in the range of the difference between the preliminary baseline and the baseline after the correction, the relative comparison part 508 changes the correlation values so that the difference between the current operation information and the baseline after the correction decreases. As a result, the baseline after the correction becomes closer to the current operation information, and accuracy of detecting an abnormality in the IT system 550 can increase. Referring to FIG. 17, a description is later given of the series of pieces of processing by the relative comparison part 508. Referring to FIG. 16, a detailed description is given of the processing of changing the correlation values by the relative comparison part 508.

The threshold generation part 505 sets thresholds for detecting an abnormality in the IT system 550 based on the baseline after the correction. The thresholds include an upper threshold and a lower threshold. The upper threshold is calculated by adding a predetermined value to the baseline after the correction, and the lower threshold is calculated by subtracting the predetermined value from the baseline after the correction.

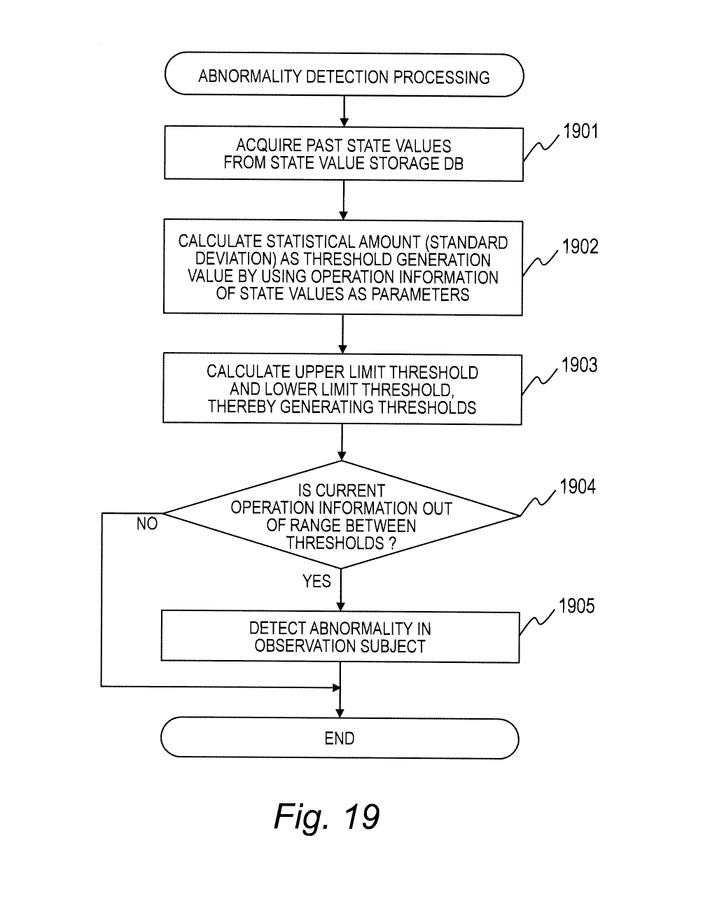

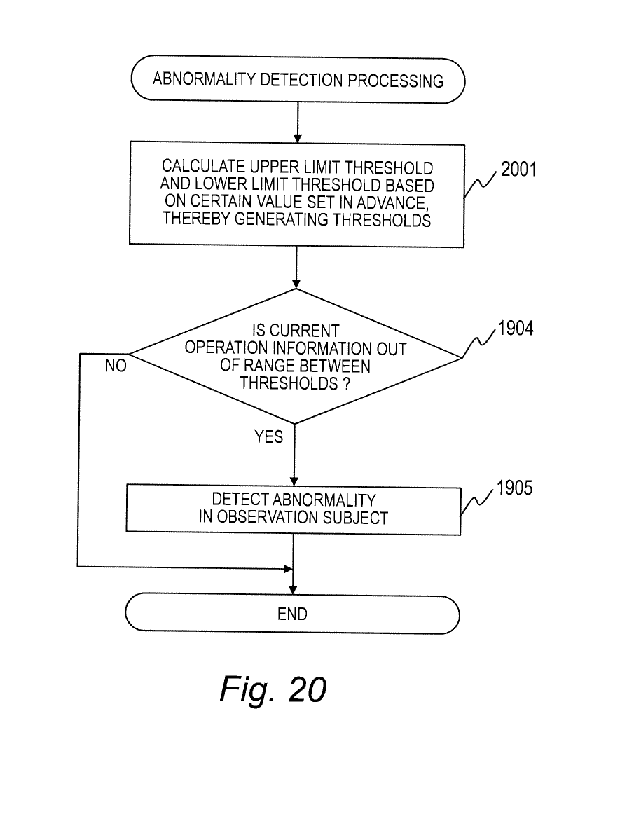

According to this embodiment, there are a method of using a statistical amount using a past state value as a parameter and a method of using a value set in advance as the predetermined value for calculating the thresholds. Referring to FIG. 19, a detailed description is given of the processing of calculating the thresholds by using the statistical amount, and, referring to FIG. 20, a detailed description is given of the processing of calculating the thresholds by using the value set in advance.

The abnormality detection part 506 determines whether or not the current configuration information is in the range between the thresholds calculated by the threshold generation part 505. If the abnormality detection part 506 determines that the current configuration information is not in the range between the thresholds calculated by the threshold generation part 505, the abnormality detection part 506 detects an abnormality in the IT system 550, and notifies the notification part 507 of the detection of the abnormality. On the other hand, if the abnormality detection part 506 determines that the current configuration information is in the range between the thresholds calculated by the threshold generation part 505, the abnormality detection part 506 determines that the IT system 550 is not abnormal.

It should be noted that the calculation processing for the thresholds by the threshold generation part 505 and the detection processing for the abnormality in the IT system 550 by the abnormality detection part 506 in combination are referred to as abnormality detection processing, and referring to FIGS. 19 and 20, a detailed description is given of the abnormality detection processing.

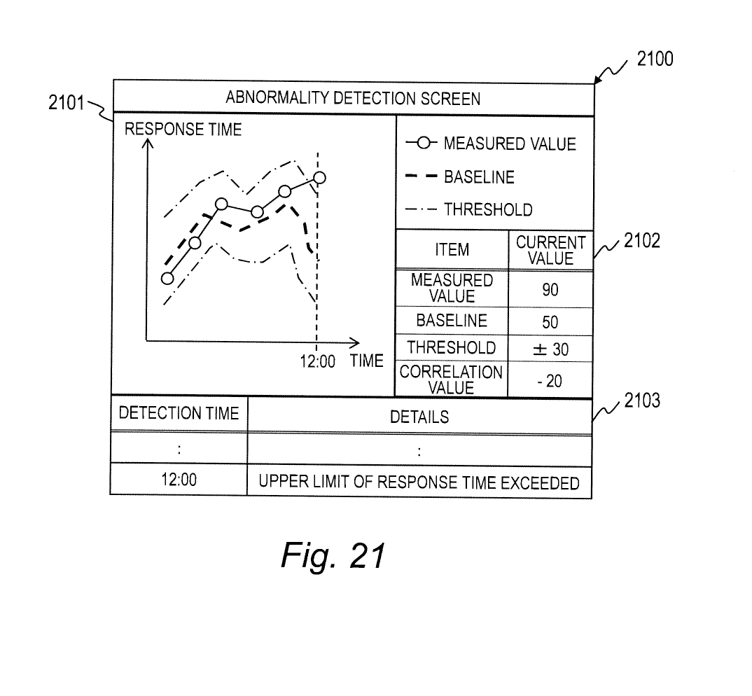

When the notification part 507 is notified of the detection of the abnormality in the IT system 550 from the abnormality detection part 506, the notification part 507 notifies the administrator of the detection of the abnormality in the IT system 550. The method of the notification includes a method of outputting an abnormality detection screen 2100 (refer to FIG. 21) on a screen of the client PC, which is not shown, connected to the failure symptom detection system 500, a method of outputting the notification from a speaker of the client PC, and a method of outputting the notification by means of a mail and the like.

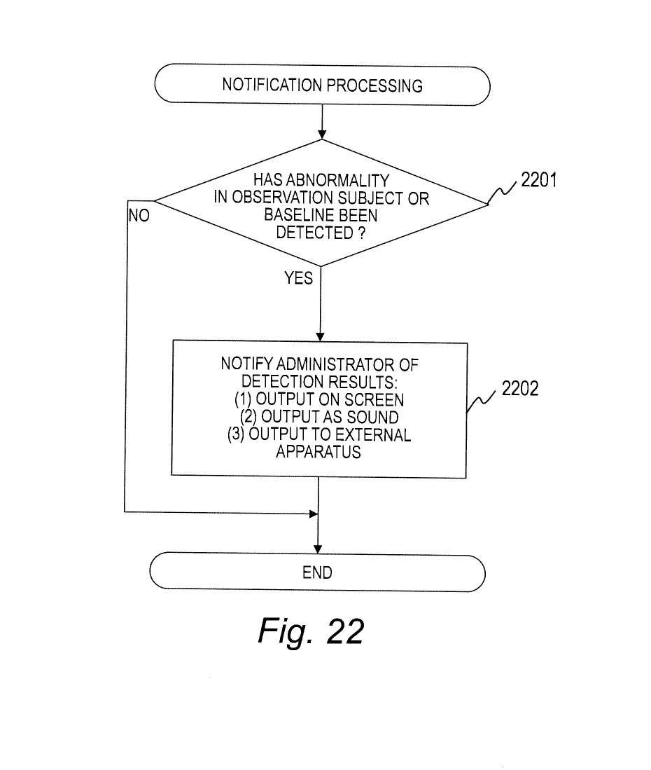

Referring to FIG. 21, a detailed description is given of the abnormality detection screen 2100, and, referring to FIG. 22, a detailed description is given of the notification processing by the notification part 507.

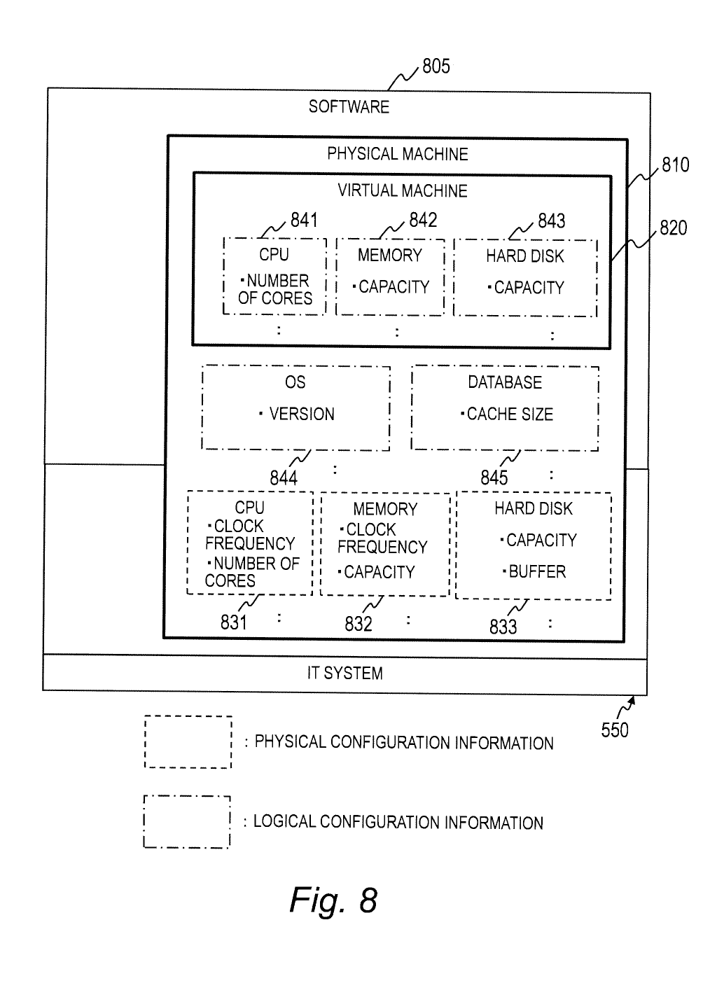

FIG. 7 is a flowchart illustrating overall processing by the failure symptom detection system 500 according to the embodiment of this invention.

This overall processing is executed by the CPU 521 provided for the failure symptom detection system 500.

First, the failure symptom detection system 500 executes the observation subject information collection processing (Step 701). The observation subject information collection processing is processing of collecting, by the state management part 501, the operation information and the configuration information from the IT system 550, and storing, by the stream data processing part 502, the operation information and the configuration information collected by the state management part 501 in the state value storage DB 511.

Then, the failure symptom detection system 500 executes the baseline generation processing (Step 702). The baseline generation processing is processing of generating, by the correction part 504, a baseline corresponding to the current configuration information.

Then, the failure symptom detection system 500 executes the relative comparison processing (Step 703). The relative comparison processing is processing of comparing, by the relative comparison part 508, the preliminary baseline and the baseline with each other.

Then, the failure symptom detection system 500 executes the abnormality detection processing (Step 704). The abnormality detection processing is processing of generating, by the threshold generation part 505, the thresholds, and determining, by the abnormality detection part 506, whether or not the current operation information is in the range between the thresholds, thereby detecting an abnormality in the IT system 550.

Then, the failure symptom detection system 500 executes the notification processing (Step 705), and finishes the overall processing. The notification processing is processing of notifying, by the notification part 507, if an abnormality is detected in the IT system 550 by the abnormality detection processing, the administrator of the abnormality.

FIG. 8 is an explanatory diagram illustrating the configuration information collected from the IT system 550 according to the embodiment of this invention. The IT system 550 includes at least one physical machine 810. A virtual machine 820 operates on a hypervisor, which is not shown, of the physical machine 810. On this occasion, the configuration information collected from the IT system 550 includes physical configuration information on the IT system 550 and logical configuration information on the IT system 550.

The physical configuration information is configuration information on physical resources (such as a CPU, a memory, and a hard disk) provided for the physical machine 810. For example, the physical configuration information includes information on a clock frequency and the number of cores of the CPU, a clock frequency and a capacity of the memory, and a capacity and a buffer size of the hard disk.

The logical configuration information is information on software 805 executed by the physical machine 810. The logical configuration information includes version information 844 on an OS executed by the physical machine 810, and a cache size 845 of the database. Moreover, the logical configuration information includes information on physical resources assigned to the virtual machine 820. The information on the physical resources assigned to the virtual machine 820 includes information 841 on the number of cores of the CPU assigned to the virtual machine 820, information 842 on a capacity of the memory assigned to the virtual machine 820, and information 843 on a capacity of the hard disk assigned to the virtual machine 820.

FIGS. 9A and 9B are explanatory diagrams illustrating the observation subject information collection processing according to the embodiment of this invention until the stream data processing part 502 stores the state values of the IT system 550 collected by the state management part 501 in the state value storage DB 511.

Part (A) of FIG. 9A is the response performance (operation information) and the configuration information on the IT system 550 made into a chart as a time series. On this occasion, the memory capacity included in the configuration information is changed from 1,024 MB to 2,048 MB, and the DB cache included in the configuration information is changed from 1 MB to 2 MB at 12:01:00. It should be noted that the memory capacity is physical configuration information, and the DB cache is logical configuration information.

Part (B) of FIG. 9A illustrates a state where the state values collected by the state management part 501 from the IT system 550 are temporarily held by the stream data processing part 502.

The state values temporality held by the stream data processing part 502 include a collection time 901, operation information 902, and configuration information 903.

A time when the state values including the operation information and the configuration information are collected by the state management part 501 is registered to the collection time 901. The state management part 501 collects the state values from the IT system 550, for example, each second as a unit.

The response performance of the IT system 550 collected at the time registered to the collection time is registered to the operation information 902. The physical configuration information (memory capacity) and the logical configuration information (DB cache) on the IT system 550 collected at the time registered to the collection time are registered to the configuration information 903.

The stream data processing part 502 averages the state values temporarily held over the predetermined time as a unit (such as one minute as a unit). An average of the state values acquired by the stream data processing part 502 is illustrated in (C) of FIG. 9A.

The stream data processing part 502 stores the average of the state values in the state value storage DB 511. The state value storage DB 511 is illustrated in part (D) of FIG. 9B. The state value storage DB 511 includes the collection times 901, the operation information 902, and the configuration information 903 similarly to the state values held by the stream data processing part 502 illustrated in part (B) of FIG. 9A. A description thereof is the same as that of part (B) of FIG. 9A, and a description thereof is therefore omitted.

FIG. 10 is a flowchart illustrating the observation subject information collection processing according to the embodiment of this invention. The observation subject information collection processing is executed by the CPU 521 invoking a program corresponding to the state management part 501 and a program corresponding to the stream data processing part 502, and executing the programs.

First, the stream data processing part 502 sets an elapsed time to zero in order to measure the time used to average the state values collected by the state management part 501 (Step 1001).

Then, the state management part 501 collects the operation information from the IT system 550 subject to the observation (Step 1002), and collects the configuration information from the IT system 550 subject to the observation (Step 1003).

Then, the state management part 501 inputs the state values which is acquired by adding the configuration information collected by the processing in Step 1003 to the operation information collected by the processing in Step 1002 into the stream data processing part 502, and the stream data processing part 502 temporarily holds the input state values (Step 1004).

Then, the stream data processing part 502 determines whether or not the elapsed time after the processing in Step 1001 was carried out exceeds the time over which the state values are averaged (Step 1005).

If the stream data processing part 502 determines that the elapsed time after the processing in Step 1001 was carried out does not exceed the time over which the state values are averaged in the processing in Step 1005, the stream data processing part 502 returns to the processing in Step 1002.

On the other hand, if the stream data processing part 502 determines that the elapsed time after the processing in Step 1001 was carried out exceeds the time over which the state values are averaged in the processing in Step 1005, the stream data processing part 502 averages the operation information and the configuration information of the state values, and stores the averaged operation information and configuration information in the state value storage DB 511 (Step 1006).

Then, the state management part 501 determines whether or not the state values for a predetermined period (such as one day) for generating the baseline have been stored in the state value storage DB 511 (Step 1007).

If the state management part 501 determines that the state values for the predetermined period (such as one day) for generating the baseline have been stored in the state value storage DB 511 in the processing in Step 1007, the state management part 501 finishes the observation subject information collection processing, and the CPU 521 executes the baseline generation processing, which is processing in Step 702 illustrated in FIG. 7.

On the other hand, if the state management part 501 determines that the state values for the predetermined period (such as one day) for generating the baseline have not been stored in the state value storage DB 511 in the processing in Step 1007, the state management part 501 returns to the processing in Step 1001.

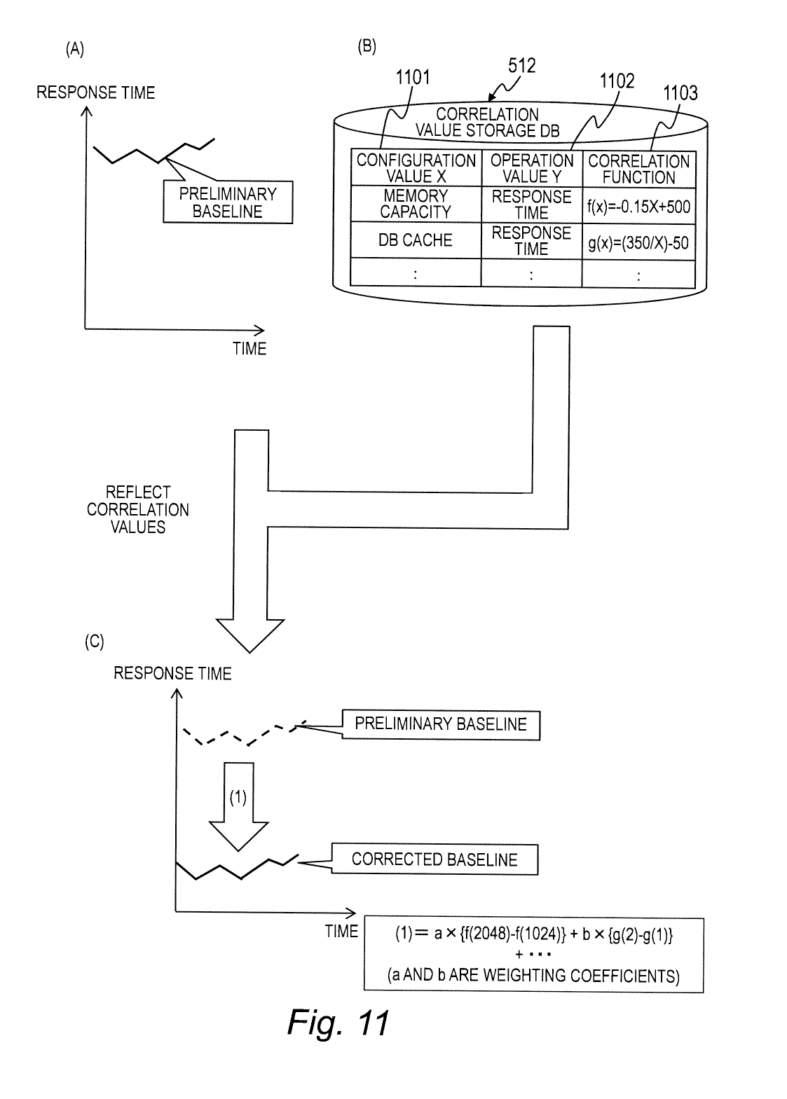

FIG. 11 is an explanatory diagram illustrating the baseline generation processing according to this invention up to the generation of the baseline.

Part (A) of FIG. 11 illustrates a preliminary baseline generated by the BL generation part 503. The preliminary baseline is calculated by the BL generation part 503 referring to the state value storage DB 511, and averaging the operation information at the same time on different days.

Part (B) of FIG. 11 is an explanatory diagram illustrating the correlation value storage DB 512. The correlation functions each representing the correspondence between the configuration information and the operation information are registered for the types of the configuration information and the types of the operation information to the correlation value storage DB 512. The correlation value storage DB 512 includes configuration values X 1101, operation values Y 1102, and correlation functions 1103.

The type of the configuration information is registered to the configuration value X 1101, and the response time is registered to the operation value Y 1102. A function passing through coordinates each represented by the configuration value and the operation value while configuration value is assigned to the X axis and the operation value is assigned to the Y axis is registered to the correlation function 1103.

Part (C) of FIG. 11 illustrates a baseline generated by the correction part 504 reflecting the correlation values in the preliminary baseline.

On this occasion, the correlation value is used to associate the past operation information used to calculate the preliminary baseline with the current configuration information. The correlation value is calculated based on the correlation function, and, referring to FIG. 12, a detailed description is given of the calculation processing for the correlation function.

If the current memory capacity is 2,048 MB, and the correlation function is represented as f(x), the correlation value of the operation information for a memory capacity of 1,024 MB is calculated by, for example, subtracting the operation information (f(1024)) for the memory capacity of 1,024 MB from the operation information (f(2048)) for the current memory capacity.

The reflection of the correlation values in the preliminary baseline is addition of the values (refer to (1) of part (C) of FIG. 11) each acquired by multiplying the correlation value corresponding to the configuration information of the operation information used to calculate the preliminary baseline by the predetermined weighting coefficient to the preliminary baseline.

As a result, the failure symptom detection system 500 can calculate the baseline associated with the current configuration information from the preliminary baseline.

FIG. 12 is an explanatory diagram illustrating the correlation function calculation processing according to the embodiment of this invention. The calculation processing for the correlation function includes correlation function automatic setting processing of referring, by the failure symptom detection system 500, to the state value storage DB 511, thereby automatically calculating the correlation function and correlation function manual setting processing of manually setting, by the administrator, the correlation function. First, a description is given of the correlation function automatic setting processing.

The correction part 504 plots the configuration information and the operation information stored in the state value storage DB 511 while the configuration information is assigned to the x axis, and the operation information is assigned to the y axis. It should be noted that if a plurality of pieces of operation information exist for the same configuration information, the correction part 504 plots an average of the plurality of pieces of operation information as the operation information.

Then, the correction part 504 calculates the function passing through the coordinates represented by the plotted configuration information and operation information by means of the least square method, or the like, and sets the calculated function as the correlation function.

FIG. 12 illustrates the correlation function (f(x)=−0.15x+500) when the configuration information is the memory capacity, and the operation information is the response time, and the correlation function (g(x)=(350/x)−50) when the configuration information is the DB cache, and the operation information is the response time.

Then, the correlation part 504 registers the set correlation functions to the correlation value storage DB 512.

A description is now given of the correlation function manual setting processing.

In the correlation function manual setting processing, the correlation part 504 transmits an instruction of displaying a correlation function registration screen 1200 to the client PC, which is not shown, connected to the failure symptom detection system 500. When the client PC receives the instruction, the client PC displays the correlation function registration screen 1200.

The correlation function registration screen 1200 includes a configuration value input field 1201, an operation value input field 1202, the correlation function input field 1203, and a registration button 1204.

The configuration value input field 1201 is a field for inputting a name of the configuration information for which the correlation function is calculated. The operation value input field 1202 is a field for inputting a name of the operation information for which the correlation function is calculated. The correlation function input field 1203 is a field for inputting a correlation function for the configuration information input to the configuration value input field 1201 and the operation information input to the operation value input field 1202.

When the registration button 1204 is operated, the client PC transmits the configuration information input to the configuration value input field 1201, the operation information input to the operation value input field 1202, and the correlation function input to the correlation function input filed 1203 as correlation function input data to the failure symptom detection system 500.

When the failure symptom detection system 500 receives the correlation function input data, the correlation part 504 registers the received correlation function input data to the correlation value storage DB 512.

FIG. 13 is a flowchart illustrating the baseline generation processing of reflecting the correlation values according to the embodiment of this invention in the preliminary baseline.

The baseline generation processing is executed by the CPU 521 invoking a program corresponding to the BL generation part 503 and a program corresponding to the correction part 504, and executing the programs.

First, the BL generation part 503 acquires past state values in a period in which a preliminary baseline can be generated from the state values stored in the state value storage DB 511 (Step 1301).

Then, the BL generation part 503 calculates a statistical amount, which uses the operation information of the state values acquired by the processing in Step 1301 as a parameter, as a preliminary baseline (Step 1302).

Specifically, the BL generation part 503 calculates an average of pieces of operation information the same in the collection time as the statistic amount out of the operation information of the state values acquired by the processing in Step 1301.

Then, the BL generation part 503 determines whether or not the current configuration information and the configuration information of the past operation information used to calculate the preliminary baseline are different from each other (Step 1303).

If the BL generation part 503 determines that the current configuration information and the configuration information of the past operation information used to calculate the preliminary baseline are different from each other in the processing in Step 1303, the correction part 504 refers to the correlation value storage DB 512, thereby acquiring a correlation function for the configuration information determined to be different (Step 1304).

Then, the correction part 504 calculates correlation values of the operation information used for the calculation of the preliminary baseline based on the correlation function acquired by the processing in Step 1304 (Step 1305).

Specifically, the correction part 504 calculates a correlation value for each piece of operation information whose configuration information is different from the current configuration information out of the operation information used to calculate the preliminary baseline. The correlation value is calculated by subtracting a value acquired by assigning configuration information subject to the calculation of the correlation value to the correlation function from a value acquired by assigning the current configuration information to the correlation function.

Then, the correction part 504 reflects the correlation values calculated by the processing in Step 1305 in the preliminary baseline, thereby calculating a baseline corresponding to the current configuration information (Step 1306), and finishes the baseline generation processing.

If the BL generation part 503 determines that the current configuration information and the configuration information of the past operation information used to calculate the preliminary baseline are the same in the processing in Step 1303, the preliminary baseline corresponds to the current configuration information. Therefore, the correction part 504 does not execute the processing in Steps 1304 to 1306, but sets the preliminary baseline as a baseline, and finishes the baseline generation processing.

As a result, the baseline corresponding to the current configuration information is calculated, and a computer which can predict future operation information immediately after the configuration information changes can be provided.

FIG. 14 is a flowchart illustrating the baseline generation processing of reflecting the correlation values according to the embodiment of this invention in the state values.

First, the BL generation part 503 acquires past state values in a period in which a preliminary baseline can be generated from state values stored in the state value storage DB 511 (Step 1401).

Then, the BL generation part 503 determines whether or not the current configuration information and the configuration information of the past state values acquired by the processing in Step 1401 are different from each other (Step 1402).

If the BL generation part 503 determines that the current configuration information and the configuration information of the past state values acquired by the processing in Step 1401 are different from each other in the processing in Step 1402, the correction part 504 refers to the correlation value storage DB 512, thereby acquiring a correlation function for the configuration information determined to be different (Step 1403).

Then, the correction part 504 calculates correlation values of the operation information of the past state values acquired by the processing in Step 1401 based on the correlation function acquired by the processing in Step 1403 (Step 1404).

Specifically, the correction part 504 calculates a correlation value for each piece of operation information whose configuration information is different from the current configuration information out of the operation information of the past state values acquired by the processing in Step 1401. The correlation value is calculated by subtracting a value acquired by assigning configuration information subject to the calculation of the correlation value to the correlation function from a value acquired by assigning the current configuration information to the correlation function.

Then, the correction part 504 reflects the correlation values calculated by the processing in Step 1404 in the operation information of the past state values acquired by the processing in Step 1401 (Step 1405).

Then, the BL generation part 503 calculates a statistical amount, which uses the operation information of the past state values in which the correlation values are reflected by the processing in Step 1405 as the parameter, as a baseline (Step 1406), and finishes the baseline generation processing.

If the BL generation part 503 determines that the current configuration information and the configuration information of the past state values acquired by the processing in Step 1401 are the same in the processing in Step 1402, the BL generation part 503 calculates a statistical amount, which uses the operation information of the past state values acquired by the processing in Step 1401 as a parameter, as a baseline (Step 1407), and finishes the baseline generation processing.

As a result, the baseline corresponding to the current configuration information is calculated.

Referring to FIGS. 15 and 16, a description is now given of the processing by the relative comparison part 508. FIG. 15 is an explanatory diagram showing processing of detecting an abnormality in a baseline after the correction by the relative comparison part 508 according to the embodiment of this invention.

The relative comparison part 508 determines whether or not the current operation information is in the range between the baseline after the correction and the preliminary baseline.

As shown in FIG. 15, if the current operation information is not in the range between the baseline after the correction and the preliminary baseline, the relative comparison part 508 detects such a state that the baseline is abnormal, and notifies the notification part 507 of the abnormal state.

When the notification part 507 is notified of the detection of the abnormality in the baseline after the correction from the abnormality detection part 506, the notification part 507 notifies the administrator of the detection of the abnormality in the baseline after the correction. The method of the notification includes the method of outputting the abnormality detection screen on the screen of the client PC, which is not shown, connected to the failure symptom detection system 500, the method of outputting the notification as sound from the speaker of the client PC and the like, and the method of outputting the notification by means of a mail and the like. Referring to FIG. 21, a detailed description is given of the abnormality detection screen.

The abnormality in the baseline is caused by an abnormality in the correlation function, and the notification of the abnormality in the baseline to the administrator is namely a notification of the abnormality in the correlation function to the administrator.

FIG. 16 is an explanatory diagram illustrating processing of changing the correlation function by the relative comparison part 508 according to the embodiment of this invention. As illustrated in FIG. 16, if the current operation information is in the range between the baseline after the correction and the preliminary baseline, the relative comparison part 508 calculates the difference between the current operation information and the baseline after the correction, and determines whether or not the calculated difference is larger than a predetermined value.

If the relative comparison part 508 determines that the calculated difference is larger than the predetermined value, the relative comparison part 508 changes the correlation function so that the difference between the current operation information and the baseline calculated based on the correlation function after the change reaches the predetermined value. The change in the correlation function causes the correlation values to change.

In FIG. 16, the relative comparison part 508 determines that the difference (d) between the current operation information and the baseline after the correction is larger than the predetermined value (50), the correlation function f(x) using the memory capacity as the configuration information and the response time as the operation information is changed from f(x)=−0.15x+500 to f(x)=−0.12x+550, and the correlation function g(x) using the DB cache as the configuration information and the response time as the operation information is changed from g(x)=(350/x)−50 to g(x)=(330/x)−60.

The correction part 504 calculates the correlation values based on the correlation function after the change, and reflects the calculated correlation values in the future preliminary baseline, thereby correcting the baseline.

FIG. 17 is a flowchart illustrating the relative comparison processing by the relative comparison part 508 according to the embodiment of this invention. The relative comparison processing is executed by the CPU 521 invoking a program corresponding to the relative comparison part 508, and executing the program.

First, the relative comparison part 508 identifies a range of the operation information between the baseline after the correction and the preliminary baseline (Step 1701).

Then, the relative comparison part 508 determines whether or not the current operation information is in the range of the operation information identified by the processing in Step 1701 (Step 1702).

In the processing in Step 1702, if the relative comparison part 508 determines that the current operation information is not in the range of the operation information identified by the processing in Step 1701, the relative comparison part 508 detects the state where the baseline is abnormal (Step 1703), notifies the notification part 507 of the abnormal state, and finishes the relative comparison processing.

On the other hand, in the processing in Step 1702, if the relative comparison part 508 determines that the current operation information is in the range of the operation information identified by the processing in Step 1701, the relative comparison part 508 determines whether or not a difference between the current operation information and the baseline is equal to or more than the predetermined value (Step 1704).

If the relative comparison part 508 determines that the difference between the current operation information and the baseline is equal to or more than the predetermined value in the processing in Step 1704, the relative comparison part 508 changes the correlation functions so that the current operation information and the baseline calculated based on the correlation functions after the change is smaller than the predetermined value (Step 1705).

Then, the correction part 504 calculates correlation values of the operation information used to calculate the preliminary baseline after the current time based on the correlation functions changed by the processing in Step 1705, reflects the calculated correlation values to the preliminary baseline after the current time, thereby generating a new baseline (Step 1706), and finishes the relative comparison processing.

In FIG. 17, if the difference between the current operation information and the baseline is equal to or more than the predetermined value, the correlation functions are changed so that the difference from the baseline calculated based on the correlation functions after the change is smaller than the predetermined value in the processing in Steps 1704 and 1705. This predetermined value may be zero. In other words, if there is a difference between the current operation information and the baseline, the correlation functions may be changed so as to eliminate the difference.

As a result, if the current operation information is not in the range between the baseline after the correction and the preliminary baseline, it is conceivable that the baseline after the correction does not correspond to the current operation information, and the abnormality in the baseline after the correction is notified to the administrator according to this embodiment. As a result, the administrator can take an action such as correction of the correlation functions, and the failure symptom detection system 500 can precisely detect a failure in the IT system 550.

Moreover, the correlation functions are changed so that the difference between the current operation information and the baseline calculated based on the correlation functions after the change decreases, thereby changing the correlation values. On this occasion, the correlation function set by the correlation function automatic setting processing or the correlation function manual setting processing may not precisely represent the correspondence between the operation information and the configuration information. This is because, if a plurality of pieces of operation information exist for one piece of configuration information, the correlation function set by the correlation function automatic setting processing is set by averaging the plurality of pieces of operation information, and the correlation function set by the correlation function manual setting processing is arbitrarily specified by the administrator. The change processing for the correlation function can change such a correlation function so as to correspond to the current operation information according to this embodiment.

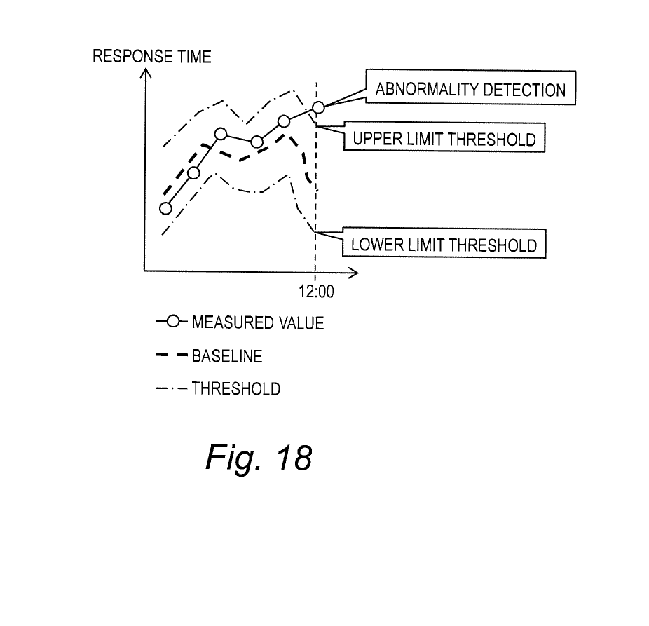

FIG. 18 is an explanatory diagram showing the abnormality detection processing according to the embodiment of this invention. In the abnormality detection processing, the abnormality detection part 506 determines whether or not the current operation information is in the range between the upper limit threshold and the lower limit threshold generated by the threshold generation part 505, and if the abnormality detection part 506 determines that the current operation information is not in the range between the upper limit threshold and the lower limit threshold generated by the threshold generation part 505, the abnormality detection part 506 detects an abnormality in the IT system 550. It should be noted that the threshold generation part 505 calculates the thresholds by means of statistical-amount-using threshold calculation processing of using a statistical amount of past operation information for calculation, or certain-value-using threshold calculation processing of using a certain value set in advance for calculation. Referring to FIG. 19, a detailed description is given of the statistical-amount-using threshold calculation processing, and, referring to FIG. 20, a detailed description is given of the certain-value-using threshold calculation processing.

In FIG. 18, the current operation information is larger than the upper limit threshold, and the abnormality detection part 506 thus detects an abnormality in the IT system 550.

FIG. 19 is a flowchart illustrating the abnormality detection processing when the thresholds are calculated by the statistical-amount-using threshold calculation processing according to the embodiment of this invention. The abnormality detection processing is executed by the CPU 521 invoking a program corresponding to the threshold generation part 505 and a program corresponding to the abnormality detection part 506, and executing the programs.

First, the threshold generation part 505 acquires the past state values used to generate the baseline from the state value storage DB 511 (Step 1901).

Then, the threshold generation part 505 calculates a statistical amount, which uses the operation information of the past state values acquired by the processing in Step 1901 as a parameter, as a threshold generation value for generating the thresholds (Step 1902). Specifically, the threshold generation part 505 calculates an average (overall average) of the entire operation information of the past state values, and calculates a standard deviation from the overall average of averages of operation information the same in collection time out of the past state values as the threshold generation value.

Then, the threshold generation part 505 calculates the upper limit threshold by adding the threshold generation value at each time calculated by the processing in Step 1902 to the baseline at each time, and calculates the lower limit threshold by subtracting the threshold generation value at each time calculated by the processing in Step 1902 from the baseline at each time (Step 1903). As a result, the thresholds are generated.

Then, the abnormality detection part 506 determines whether or not the current operation information is in the range between the upper limit threshold and the lower limit threshold (Step 1904). Specifically, the abnormality detection part 506 determines that the current operation information is in the range between the upper limit threshold and the lower limit threshold if the current operation information is equal to or less than the upper limit threshold and the current operation information is equal to or more than the lower limit threshold, and determines that the current operation information is not in the range between the upper limit threshold and the lower limit threshold if the current operation information is more than the upper limit threshold or the current operation information is less than the lower limit threshold.

In the processing in Step 1904, if the abnormality detection part 506 determines that the current operation information is not in the range between the upper limit threshold and the lower limit threshold, the abnormality detection part 506 detects an abnormality in the IT system 550, notifies the notification part 507 of the abnormal state (Step 1905), and finishes the abnormality detection processing.

On the other hand, in the processing in Step 1904, if the abnormality detection part 506 determines that the current operation information is in the range between the upper limit threshold and the lower limit threshold, the abnormality detection part 506 does not detect an abnormality in the IT system 550, but finishes the abnormality detection processing.

FIG. 20 is a flowchart illustrating the abnormality detection processing when the thresholds are calculated by the certain-value-using threshold calculation processing according to the embodiment of this invention. It should be noted that, in the abnormality detection processing illustrated in FIG. 20, like processing as of FIG. 19 are denoted by like numerals, and a description thereof is therefore omitted.

First, the threshold generation part 505 adds a certain value set in advance to a baseline to calculate the upper limit threshold, and subtracts the certain value set in advance from the baseline to calculate the lower limit threshold, thereby generating the thresholds (Step 2001).

It should be noted that the processing in Steps 1904 and 1905 is the same as that in FIG. 19, and a description thereof is therefore omitted.

FIG. 21 is an explanatory diagram illustrating the abnormality detection screen 2100 according to the embodiment of this invention. The abnormality detection screen 2100 is a screen displayed when a state where an abnormality in the IT system 550 is detected, or a state where an abnormality in the baseline is detected is input to the notification part 507 in order to notify the administrator of the abnormality.

The abnormality detection screen 2100 includes an operation information chart display field 2101, an abnormality detection related information display field 2102, and an abnormality detection log display field 2103.

The operation information, the baseline, the upper limit threshold, and the lower limit threshold in a predetermined period until an abnormality is detected are displayed in the operation information chart display field 2101.

A measured value of the operation information, the baseline, the thresholds, and the correlation value at a time when the abnormality is detected are displayed in the abnormality detection related information display field 2102.

Detected times of the respective abnormalities detected up to the present time, and a detailed content representing whether each of the abnormalities detected up to the present time is an abnormality in the IT system 550 or an abnormality in the baseline are displayed in the abnormality detection log display field 2103. If an abnormality in the IT system 550 is displayed in the abnormality detection log display field 2103, information representing whether the abnormality in the IT system 550 is caused by the operation information increasing above the upper limit or decreasing below the lower limit is also displayed in the detailed content.

FIG. 22 is a flowchart illustrating the notification processing according to the embodiment of this invention. The notification processing is executed by the CPU 521 invoking a program corresponding to the notification part 507, and executing the program.

First, the notification part 507 determines whether or not a detection of an abnormality in the IT system 550 or a detection of an abnormality in the baseline is input from the abnormality detection part 506 (Step 2201).

In the processing in Step 2201, if the notification part 507 determines that a detection of an abnormality in the IT system 550 or a detection of an abnormality in the baseline is input from the abnormality detection part 506, the notification part 507 notifies the administrator of the input of the generation of the abnormality (Step 2202), and finishes the notification processing.

The method of the notification to the administrator includes the method of outputting the abnormality detection screen 2100 on the screen of the client PC, which is not shown, connected to the failure symptom detection system 500, the method of outputting the notification as sound from the speaker of the client PC and the like, and the method of outputting the notification by means of a mail and the like to an external apparatus.

This invention has been described in detail so far with reference to the accompanying drawings, but this invention is not limited to those specific configurations described above, and various changes and equivalent components are included within the gist of the scope of claims appended.

What is claimed is:

1. An operation information prediction computer for collecting operation information on at least one apparatus from the at least one apparatus and predicting future operation information on the at least one apparatus based on the collected operation information, the operation information prediction computer comprising:
a storage area;
a state information collection part for collecting, from the at least one apparatus, state information including the operation information and configuration information on the at least one apparatus when the operation information is collected;
a state information storage part for storing, in the storage area, the operation information and the configuration information collected by the state information collection part;
a correlation value calculation part for calculating a correlation value for associating past operation information stored in the storage area by the state information storage part with current configuration information; and
an operation prediction value calculation part for calculating a future operation prediction value based on the past operation information and the correlation value calculated by the correlation value calculation part.

2. An operation information prediction computer according to claim 1, wherein the correlation value calculation part is configured to:
calculate a correlation function representing a relationship between the configuration information and the operation information based on a plurality of pieces of operation information stored in the storage area by the state information storage part, and pieces of configuration information when the plurality of pieces of operation information are collected;
calculate operation information corresponding to the current configuration information and operation information corresponding to the past configuration information based on the correlation function; and
subtract the operation information corresponding to the past configuration information from the operation information corresponding to the current configuration information, thereby calculating the correlation value.

3. An operation information prediction computer according to claim 1, wherein the operation prediction value calculation part is configured to:
calculate a preliminary operation prediction value based on the past operation information; and
correct the calculated preliminary operation prediction value based on the correlation value, thereby calculating the future operation prediction value.

4. An operation information prediction computer according to claim 1, wherein the operation prediction value calculation part is configured to:
convert the past operation information into operation information corresponding to the current configuration information based on the correlation value; and
calculate the future operation prediction value based on the converted operation information.

5. An operation information prediction computer according to claim 1, wherein:
the operation prediction value calculation part is configured to calculate a preliminary operation prediction value based on the past operation information; and
the operation information prediction computer further comprises:
a comparison part for determining whether or not current operation information collected by the state information collection part is in a range between the preliminary operation prediction value and the future operation prediction value;
an operation prediction value abnormality notification part for transmitting, in a case where the comparison part determines that the current operation information collected by the state information collection part is outside the range between the preliminary operation prediction value and the future operation prediction value, such a notification that the future operation prediction value is abnormal; and
a correlation value change part for changing, in a case where the comparison part determines that the current operation information collected by the state information collection part is in the range between the preliminary operation prediction value and the future operation prediction value, the correlation value so that a difference between the current operation information collected by the state information collection part and the future operation prediction value decreases.

6. An operation information prediction computer according to claim 1, further comprising a threshold calculation part for adding a predetermined value to the future operation prediction value to calculate an upper limit threshold, and subtracting a predetermined value from the future operation prediction value to calculate a lower limit threshold,
wherein the threshold calculation part is configured to set, as the predetermined value, one of a statistical amount of the past operation information used by the operation prediction value calculation part to calculate the future operation prediction value and a certain value set in advance.

7. An operation information prediction computer according to claim 6, further comprising an apparatus abnormality notification part for reporting, when current operation information collected by the state information collection part is outside a range between the upper limit threshold and the lower limit threshold, such a situation that the at least one apparatus is abnormal.

8. An operation information prediction computer according to claim 1, wherein the configuration information includes at least one of physical configuration information or logical configuration information on the at least one apparatus.

9. An operation information prediction computer according to claim 8, wherein:
the physical configuration information includes at least one of a performance value or a number of physical resources provided for the at least one apparatus; and
the logical configuration information includes at least one of a requirement for physical resources assigned to a virtual apparatus generated by the at least one apparatus, version information on software executed on the at least one apparatus, or a tuning parameter for the software.

10. An operation information prediction method for collecting, by a computer including a storage area, operation information on at least one apparatus from the at least one apparatus, and predicting future operation information on the at least one apparatus based on the collected operation information, the operation information prediction method comprising:
a step of collecting, from the at least one apparatus, state information including the operation information and configuration information on the at least one apparatus when the operation information is collected;
a step of storing, in the storage area, the state information including the operation information and the configuration information collected in the step of collecting state information;
a step of calculating a correlation value for associating past operation information stored in the storage area in the step of storing the state information with current configuration information; and
a step of calculating a future operation prediction value based on the past operation information and the correlation value calculated in the step of calculating a correlation value.

11. An operation information prediction method according to claim 10, wherein the step of calculating a correlation value comprises:
a step of calculating a correlation function representing a relationship between the configuration information and the operation information based on a plurality of pieces of operation information stored in the storage area in the step of storing the state information, and pieces of configuration information when the plurality of pieces of operation information are collected;
a step of calculating operation information corresponding to the current configuration information and operation information corresponding to the past configuration information based on the correlation function; and
a step of subtracting the operation information corresponding to the past configuration information from the operation information corresponding to the current configuration information, thereby calculating the correction value.

12. An operation information prediction method according to claim 10, wherein the step of calculating a future operation prediction value comprises:
a step of calculating a preliminary operation prediction value based on the past operation information; and
a step of correcting the calculated preliminary operation prediction value based on the correlation value, thereby calculating the future operation prediction value.

13. An operation information prediction method according to claim 10, wherein the step of calculating a future operation prediction value comprises:
a step of converting the past operation information into operation information corresponding to the current configuration information based on the correlation value; and
a step of calculating the future operation prediction value based on the converted operation information.

14. An operation information prediction method according to claim 10, wherein:
the step of calculating a future operation prediction value comprises a step of calculating a preliminary operation prediction value based on the past operation information; and
the operation information prediction method further comprises:
a step of comparing to determine whether or not current operation information collected in the step of collecting state information is in a range between the preliminary operation prediction value and the future operation prediction value;
a step of transmitting, in a case where it is determined in the step of comparing that the current operation information collected in the step of collecting state information is outside the range between the preliminary operation prediction value and the future operation prediction value, such a notification that the future operation prediction value is abnormal; and
changing, in a case where it is determined in the step of comparing that the current operation information collected in the step of collecting state information is in the range between the preliminary operation prediction value and the future operation prediction value, the correlation value so that a difference between the current operation information collected in the step of collecting state information and the future operation prediction value decreases.

15. A program for controlling, in a computer for collecting operation information on at least one apparatus from the at least one apparatus, the computer including a processor and a storage area, the processor to execute processing of predicting future operation information on the at least one apparatus based on the collected operation information, the processing comprising:
a step of collecting, from the at least one apparatus, state information including the operation information and configuration information on the at least one apparatus when the operation information is collected;
a step of storing, in the storage area, the state information including the operation information and the configuration information collected in the step of collecting state information;
a step of calculating a correlation value for associating past operation information stored in the storage area in the step of storing the state information with current configuration information; and
a step of calculating a future operation prediction value based on the past operation information and the correlation value calculated in the step of calculating a correlation value.

16. A program according to claim 15, wherein the step of calculating a correlation value comprises:
a step of calculating a correlation function representing a relationship between the configuration information and the operation information based on a plurality of pieces of operation information stored in the storage area in the step of storing the state information, and pieces of configuration information when the plurality of pieces of operation information are collected;
a step of calculating operation information corresponding to the current configuration information and operation information corresponding to the past configuration information based on the correlation function; and
a step of subtracting the operation information corresponding to the past configuration information from the operation information corresponding to the current configuration information, thereby calculating the correction value.

17. A program according to claim 15, wherein the step of calculating a future operation prediction value comprises:
a step of calculating a preliminary operation prediction value based on the past operation information; and
a step of correcting the calculated preliminary operation prediction value based on the correlation value, thereby calculating the future operation prediction value.

18. A program according to claim 15, wherein the calculating a future operation prediction value comprises:
a step of converting the past operation information into operation information corresponding to the current configuration information based on the correlation value; and
a step of calculating the future operation prediction value based on the converted operation information.

19. A program according to claim 15, wherein:
the step of calculating a future operation prediction value comprises a step of calculating a preliminary operation prediction value based on the past operation information; and
the processing further comprises:
a step of comparing to determine whether or not current operation information collected in the step of collecting state information is in a range between the preliminary operation prediction value and the future operation prediction value;
a step of transmitting, in a case where it is determined in the step of comparing that the current operation information collected in the step of collecting state information is outside the range between the preliminary operation prediction value and the future operation prediction value, such a notification that the future operation prediction value is abnormal; and
changing, in a case where it is determined in the step of comparing that the current operation information collected in the step of collecting state information is in the range between the preliminary operation prediction value and the future operation prediction value, the correlation value so that a difference between the current operation information collected in the step of collecting state information and the future operation prediction value decreases.
